(19) United States
(12) Patent Application Publication
(10) Pub. No.: US 2023/0306092 A1
(43) Pub. Date: Sep. 28, 2023

(54) CONTROL METHOD, COMPUTER PROGRAM PRODUCT, AND STORAGE MEDIUM

(71) Applicant: Panasonic Intellectual Property Management Co., Ltd., Osaka (JP)

(72) Inventors: Hiroshi Yahata, Osaka Fu (JP); Tomoyuki Hirota, Hyogo Ken (JP); Takahiro Nishi, Nara Ken (JP); Tadamasa Toma, Osaka Fu (JP); Toshiyasu Sugio, Osaka Fu (JP)

(73) Assignee: Panasonic Intellectual Property Management Co., Ltd., Osaka (JP)

(21) Appl. No.: 18/121,930

(22) Filed: Mar. 15, 2023

(30) Foreign Application Priority Data
Mar. 22, 2022 (JP) 2022-045964
Jan. 20, 2023 (JP) 2023-007031

(51) Int. Cl. G06F 21/31; G07C 5/12; G06Q 40/08; B60R 25/24; B60R 25/01

(52) U.S. Cl. CPC G06F 21/31; G07C 5/12; G06Q 40/08; B60R 25/24; B60R 25/01

(57) ABSTRACT

A control method according to the present disclosure is a control method in a first computer configured to access a database managing information on vehicles and electronic keys. The control method includes receiving, from a terminal of a user, authentication information including an electronic key and an identification for a vehicle; after determining that the authentication information is valid, transmitting, to the vehicle, a signal indicating that the user is permitted to use the vehicle; after the user starts using the vehicle, acquiring use information indicating a status of use of the vehicle from the vehicle; transmitting, when the electronic key is a company key correlated with a business entity, at least a part of the use information to a second computer related to the business entity; and not transmitting the use information when the electronic key is a personal key of the user.

### CROSS-REFERENCE TO RELATED APPLICATIONS

This application is based upon and claims the benefit of priority from Japanese Patent Application No. 2022-045964, filed on Mar. 22, 2022 and Japanese Patent Application No. 2023-007031, filed on Jan. 20, 2023, the entire contents of which are incorporated herein by reference.

### FIELD

Embodiments described herein relate generally to a control method for controlling a computer capable of communicating with a vehicle, a computer program product, and a storage medium.

### BACKGROUND

JP 2012-67489 A discloses a method for changing a cipher key for an electronic key system to a cipher key for a valet mode when a vehicle operation mode is switched from a normal mode to the valet mode.

However, the technique described in JP 2012-67489 A requires further improvement.

### SUMMARY

A control method according to an aspect of the present disclosure is performed in a first computer configured to access at least one database managing vehicle information on a plurality of vehicles and a plurality of electronic keys corresponding to the plurality of vehicles. The control method includes: receiving, from a first terminal of a first user via a network, first authentication information including a first electronic key available to the first user and a first vehicle identification (ID) for identifying a first vehicle that the first user requests to use; determining that the first authentication information is valid based on the first electronic key, the first vehicle ID, and the at least one database, and then transmitting, to the first vehicle via the network, a first permission signal indicating that the first user is permitted to use the first vehicle; after the first user starts using the first vehicle, acquiring first use information indicating a status of use of the first vehicle from the first vehicle via the network; transmitting, in a case where the first electronic key is a first company key correlated with a first business entity that the first user belongs to, at least a part of the first use information to a second computer related to the first business entity via the network; and not transmitting, in a case where the first electronic key is a first personal key of the first user, the at least a part of the first use information to the second computer.

### BRIEF DESCRIPTION OF THE DRAWINGS

FIG. 1 is a block diagram illustrating an example of the overall configuration of a key management system according to a first embodiment;

FIG. 2 is a block diagram illustrating an example of the configuration of a key management system according to the first embodiment;

FIG. 3 is a flowchart illustrating an example of issuing a key for an owner according to the first embodiment;

FIG. 4 is a flowchart illustrating an example of issuing a key for a temporary user according to the first embodiment;

FIG. 5 is a flowchart illustrating an example from unlocking to locking according to the first embodiment;

FIG. 6 is a diagram illustrating an example of key data according to the first embodiment;

FIG. 7 is a flowchart illustrating an example of setting a vehicle function according to a key type according to the first embodiment;

FIG. 8 is a flowchart illustrating an example of setting a vehicle function according to a key ID according to the first embodiment;

FIG. 9 is a diagram illustrating an example of a screen of a car navigation system displayed for an owner according to the first embodiment;

FIG. 10 is a diagram illustrating an example of a screen of a car navigation system displayed for a temporary/joint user according to the first embodiment;

FIG. 11 is a diagram illustrating an example of a screen of a car navigation system displayed for an owner according to the first embodiment;

FIG. 12 is a diagram illustrating an example of a screen of a car navigation system displayed for a temporary/joint user according to the first embodiment;

FIG. 13 is a diagram illustrating an example of a screen of a cockpit displayed for an owner according to the first embodiment;

FIG. 14 is a diagram illustrating an example of a screen of a cockpit displayed for a temporary/joint user according to the first embodiment;

FIG. 15 is a flowchart illustrating an example of notification processing in a vehicle that is being used by a temporary/joint user according to the first embodiment;

FIG. 16 is a flowchart illustrating an example of notification processing in a vehicle that is being used by a family/temporary/joint user according to the first embodiment;

FIG. 17 is a flowchart illustrating an example of a usage notification to a joint user according to the first embodiment;

FIG. 18 is a block diagram illustrating an example of the overall configuration of a key management system according to a second embodiment;

FIG. 19 is a block diagram illustrating an example of the configuration of a key management system according to the second embodiment;

FIG. 20 is a flowchart illustrating an example of processing of a key management system according to the second embodiment;

FIG. 21 is a sequence diagram from when a user uses a company electronic key to start using a vehicle that is a general-purpose shared car for company use to when the user finishes using the vehicle according to the second embodiment;

FIG. 22 is a sequence diagram from when a user uses a personal electronic key to start using a vehicle that is a general-purpose shared car for private use to when the user finishes using the vehicle according to the second embodiment;

FIG. 23 is a sequence diagram for a case where the validity of an insurance contract cannot be confirmed in a personal insurance cloud according to the second embodiment;

FIG. 24 is a flowchart for explaining calculation of an insurance premium in a company insurance cloud according to the second embodiment;

FIG. 25 is a flowchart illustrating that control is automatically changed according to the type of an electronic key used for a vehicle according to the second embodiment;

FIG. 26 is a diagram illustrating a vehicle state and a battery storage amount for a case where the vehicle is used with a personal electronic key for private use according to the second embodiment;

FIG. 27 is a sequence diagram for a case where a vehicle is used with a company electronic key according to the second embodiment;

FIG. 28 is a sequence diagram for a case where a vehicle is used with a company electronic key according to the second embodiment;

FIG. 29 is a flowchart for explaining a method for calculating a usage fee to a shared car operating company in FIGS. 21, 22, and 23;

FIGS. 30A to 30D are diagrams illustrating examples of displaying a battery storage amount of a vehicle according to the second embodiment;

FIG. 31 is a diagram illustrating screen transitions of an information terminal at the start of use according to the second embodiment;

FIG. 32 is a diagram illustrating screen transitions of an information terminal at the end of use according to the second embodiment; and

FIG. 33 is a diagram illustrating an example of a cockpit during use of a vehicle according to the second embodiment.

### DETAILED DESCRIPTION

### Background to the Present Disclosure

The environment surrounding our daily lives is increasingly digitized. For example, many people have a smartphone, which is a private information terminal, and people install and use various applications (hereinafter, referred to as applications) such as an application to manage user's health and a social communication application to communicate with other people on the smartphone.

The present disclosure discloses a technology for supporting a user so that the user can have a healthy, happy, comfortable, convenient, reassuring, safe, pleasant, economical, and reasonable life by cooperatively operating a smartphone that is an information terminal having various information processing capabilities, an application running on the smartphone, and an information processing server (hereinafter, referred to as a cloud) that manages and provides various information.

The present disclosure can also be implemented as a computer program product including programmed instructions that cause a computer to execute each characteristic configuration included in a control method used herein, or as a system operated based on the programmed instructions. Further, it goes without saying that such programmed instructions can be distributed via a computer-readable non-transitory storage medium such as an SD card or a communication network such as the Internet.

Note that the embodiments described below provide a specific example of the present disclosure. The numerical values, shapes, constituent elements, steps, the order of the steps, and the like given in the following embodiments are merely examples, and are not intended to limit the present disclosure. Further, among the constituent elements in the following embodiments, a constituent element not recited in any of the independent claims indicating the most generic concept is described as an arbitrary constituent element. Further, in all the embodiments, the respective contents can be combined.

First Aspect

In our society, it is expected that the Internet will become even more pervasive and various sensors will become more accessible. As a result, in our society, it is expected that information on the internal conditions, activities, and the like of individuals as well as information on the entire town including buildings and transportation networks will be digitized and made available in a computer system. Digitized personal data (personal information) is securely managed as big data in a cloud server such as a personal information bank via a communication network, and is used for various purposes for individuals and society.

Such an advanced information society is called Society 5.0 in Japan. The advanced information society is a society in which economic development and solution to social problems are expected by an information base (cyber-physical system) implemented by highly integrating a real space (physical space) that is a material world surrounding an individual and a virtual space (cyberspace) in which various processing related to the physical space are performed in cooperation with computers.

In such an advanced information society, communication (including acquiring and providing information, and a method for expressing the same) and behavior in various scenes in an individual's daily life are analyzed, and big data including accumulated personal information is analyzed, which makes it possible to provide information and services necessary for the individual by a communication method considered to be optimal for the individual according to the scene.

Hereinafter, a specific aspect is described in which various users share and use vehicles in different forms in an advanced information society in which such a cyber-physical system operates.

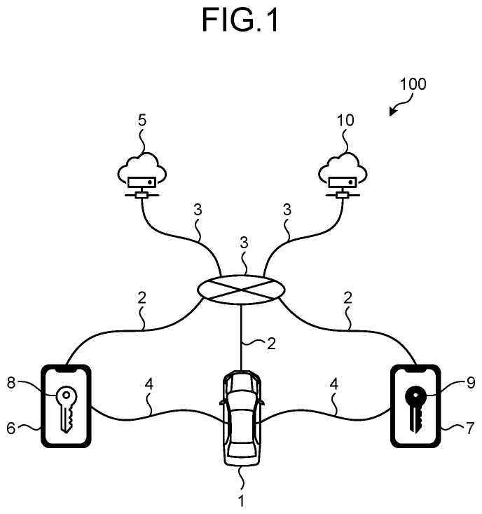

FIG. 1 is a block diagram illustrating an example of the overall configuration of a key management system 100 according to an embodiment of the present disclosure. Here, the description is given on the assumption that a vehicle 1 owned by a user A is used separately by the user A who is the owner of the vehicle 1 and a user B who is a user thereof. The vehicle 1 can access various types of information by connecting to the Internet that is a wide-area network 3 using a wireless communication standard such as cellular communication 2 called 4G or 5G. The vehicle 1 can also perform near field communication 4 with a device in close proximity using Bluetooth (registered trademark), ultra wide band (UWB) that is an ultra-wide band wireless communication standard, or the like. Further, the vehicle 1 can acquire and update an electronic key with which to use the vehicle 1 from a vehicle management cloud 5 via the Internet.

The user A owns an information terminal 6, and the user B owns an information terminal 7. The information terminals 6 and 7 store, therein, an electronic key 8 and an electronic key 9 for using the vehicle 1, respectively. The electronic keys 8 and 9 necessary to use the vehicle 1 are generated and acquired by a key management cloud 10 and the information terminals 6 and 7 that communicate bidirectionally via the Internet.

In the present disclosure, in a case where the user A who is the owner of the vehicle 1 permits the user B who is another person to use the vehicle 1, the user A issues the electronic key 9 for a temporary user with the key management cloud 10, and the user A transmits the electronic key 9 to the information terminal 7 of the user B; however, the present disclosure is not limited thereto. Any method may be used as long as the electronic key 9 that can use the vehicle 1 can be transmitted to the information terminal 7 of the user B with the permission of the user A who is the owner.

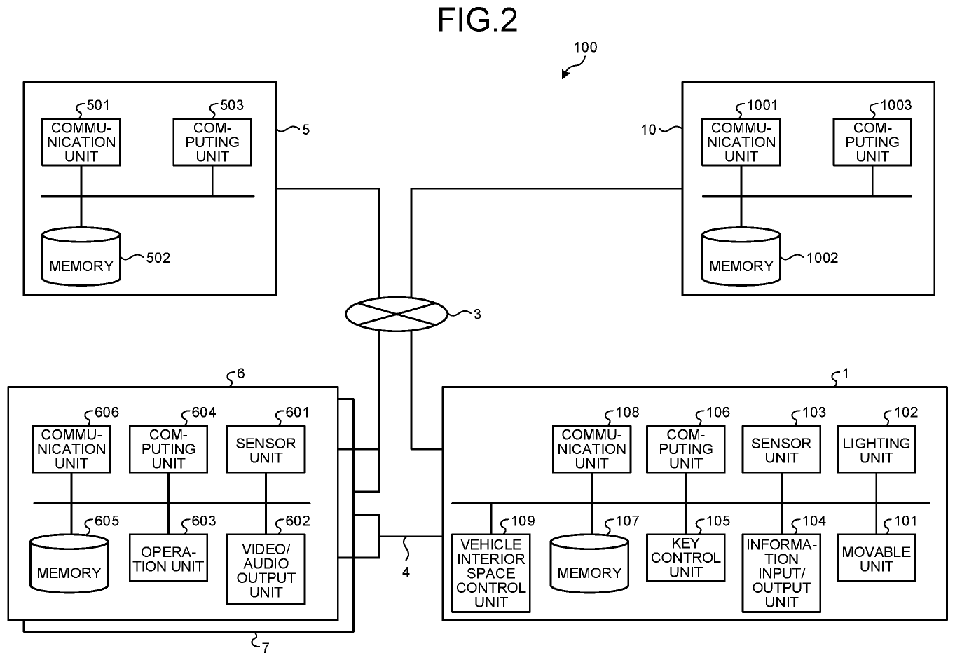

FIG. 2 is a block diagram illustrating an example of the configuration of the key management system 100. The information terminal 6 includes a sensor unit 601 for acquiring video information, audio information, and/or a physical quantity of a surrounding environment, a video/audio output unit 602 for outputting video and audio, an operation unit 603 for receiving button pressing, touch operation, or the like from a user, a computing unit 604 for performing information processing such as various calculations and information drawing performed in the information terminal, a memory 605 for holding data and files used by the computing unit 604, and a communication unit 606 for communicating with another computer on the communication network.

In response to an application for key management installed on the information terminal 6, a program and necessary data are recorded in the memory 605 of the information terminal 6, and the computing unit 604 executes the program. The hardware configuration of the information terminal 7 is also similar to the hardware configuration of the information terminal 6. Accordingly, as for the hardware configuration of the information terminal 7, refer to the description of the hardware configuration of the information terminal 6 described above.

In the meantime, the description is provided by taking an example in which the information terminals 6 and 7 are smartphones, but the information terminals 6 and 7 are not limited thereto. The information terminals 6 and 7 may be a smartwatch in the form of wristwatch, a smart glass in the form of glasses, a smart ring in the form of ring, a voice-activated smart speaker, or a robot including a movable part.

The vehicle management cloud 5 includes a communication unit 501 for communicating with another computer on the communication network, a memory 502 in which information regarding a vehicle and a user and a management program thereof are recorded, and a computing unit 503 for performing various data processing.

The key management cloud 10 includes a communication unit 1001 for communicating with another computer on the communication network, a memory 1002 in which information regarding a vehicle and a user and a management program thereof are recorded, and a computing unit 1003 for performing various data processing.

The vehicle 1 includes a movable unit 101 for moving the vehicle 1 and a device (such as a seat) in a vehicle interior space, a lighting unit 102 for illuminating an area around the vehicle, a sensor unit 103 for detecting a position and a state of a person and a car around the vehicle and a person and an object in the vehicle interior, an information input/output unit 104 that provides various video/audio information to a passenger and receives an input such as a touch operation and an audio operation from the passenger, a key control unit 105 that authenticates a key to unlock the vehicle 1 and controls locking/unlocking of a door of the vehicle 1, a computing unit 106 for executing various processing related to a vehicle core system and a vehicle function, a memory 107 in which various data including a program of the vehicle core system and a database for key management are recorded, a communication unit 108 for performing wireless communication with an external device, and a vehicle interior space control unit 109 that sets air conditioning for a driver seat, and/or air conditioning for the entire vehicle interior, and sets the presence or absence of power supply to a USB port provided in the vehicle, a maximum current amount, and a supported version of a universal serial bus (USB) standard.

In the meantime, the vehicle management cloud 5, the key management cloud 10, the vehicle 1, and the information terminals 6 and 7 may communicate with one another by a communication means other than the Internet that is the wide-area network 3. For example, the near field communication 4 may be used for the unlocking processing performed between the vehicle 1 and the information terminals 6 and 7.

### First Embodiment

The description goes on to a form in which the vehicle 1 shared and used by a plurality of persons is used with a plurality of electronic keys.

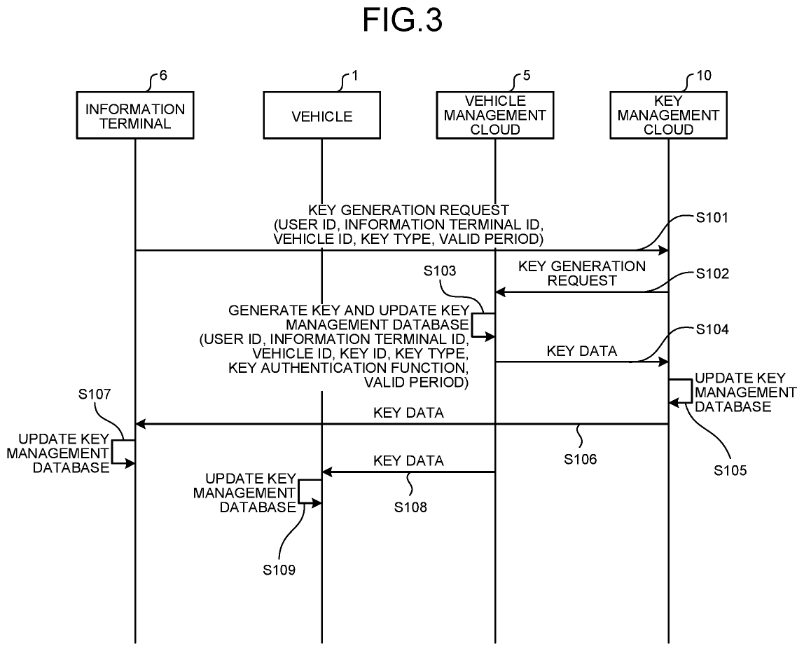

FIG. 3 is a flowchart illustrating an example of issuing a key for an owner. Here, the description will be given on the assumption that an application for key management is installed in advance on the information terminal 6 of the user A and the application is available. The main purpose of the vehicle management cloud 5 is to transmit and set encrypted key data to the vehicle.

On the other hand, the main purpose of the key management cloud 10 is to provide an electronic key management function service to the owner and a user of the vehicle 1. These clouds may be mounted in different clouds or may be mounted in one cloud. In addition, the clouds may be operated by different operators, or, the both clouds may be operated by one operator.

First, the user A requests the key management cloud 10 to generate a key for the user A who is the owner via the information terminal 6 (or, an application for key management installed on the information terminal 6 may be used, and the same applies hereafter) (Step S101). The request includes a user ID that is information for identifying a user (user A) who uses the key to be issued, an information terminal ID that is information for identifying the information terminal 6 to use the key to be issued, a vehicle ID that is information for identifying the vehicle 1 for which the key to be issued is to be used, a key type that is information for identifying the type of the key to be issued, and a valid period indicating a valid period of the key to be issued. The key type will be described later.

Upon receiving the request, the key management cloud 10 (or, a program for performing key management in the key management cloud 10 may be used, and the same applies hereafter) requests the vehicle management cloud 5 to generate a new electronic key in accordance with the received request (Step S102).

Upon receiving the request, the vehicle management cloud 5 generates a new key ID (information for identifying the corresponding electronic key) corresponding to the received user ID, information terminal ID, vehicle ID, key ID, key type, and valid period and/or a key authentication function (information defining a predetermined calculation including a hash function or the like used for key authentication between the vehicle and the information terminal), and handles the resultant as a data set related to one key.

Further, the dataset is registered in a key management database recorded in the memory 502 of the vehicle management cloud 5, and the key management database is updated (Step S103). Subsequently, the vehicle management cloud 5 transmits, to the key management cloud 10, key data including the generated key ID and/or the key authentication function (data set including the user ID, the information terminal ID, the vehicle ID, the key ID, the key type, the key authentication function, and the valid period, or a part of the data set) (Step S104).

Upon receiving the key data, the key management cloud 10 updates a key management database recorded in the memory 1002 of the key management cloud 10 (Step S105). Subsequently, the key management cloud 10 transmits the key data to the information terminal 6 that has requested to generate a key (Step S106). The information terminal 6 records the received key data in the memory 605 of the information terminal 6 (Step S107).

After the key management database is updated, the vehicle management cloud 5 transmits the added key data to the vehicle 1 (or, a key management program in the vehicle 1 or a key management database may be used, and the same applies hereafter) corresponding to the vehicle ID (Step S108). The communication unit 108 of the vehicle 1 receives the added key data, updates the key management database recorded in the memory 107 of the vehicle 1, and stores the added key data (Step S109).

In the meantime, the transmission of the key data from the vehicle management cloud 5 to the vehicle 1 is handled as the addition of a new electronic key, but the present disclosure is not limited thereto. For example, the vehicle management cloud 5 may include a command to discard or disable all key data related to a user ID of an inappropriate user in the key management database currently stored in the vehicle 1 so that the inappropriate user cannot use the vehicle 1.

Upon receiving the command, the vehicle 1 makes settings to discard or disable all the key data related to the user ID from the key management database in the memory 107 of the vehicle 1. The processing of setting to disable the key data may be performed, for example, by setting a valid period corresponding to that key to a value indicating the past or a value indicating “not available”. As a result, the inappropriate user can no longer use the vehicle.

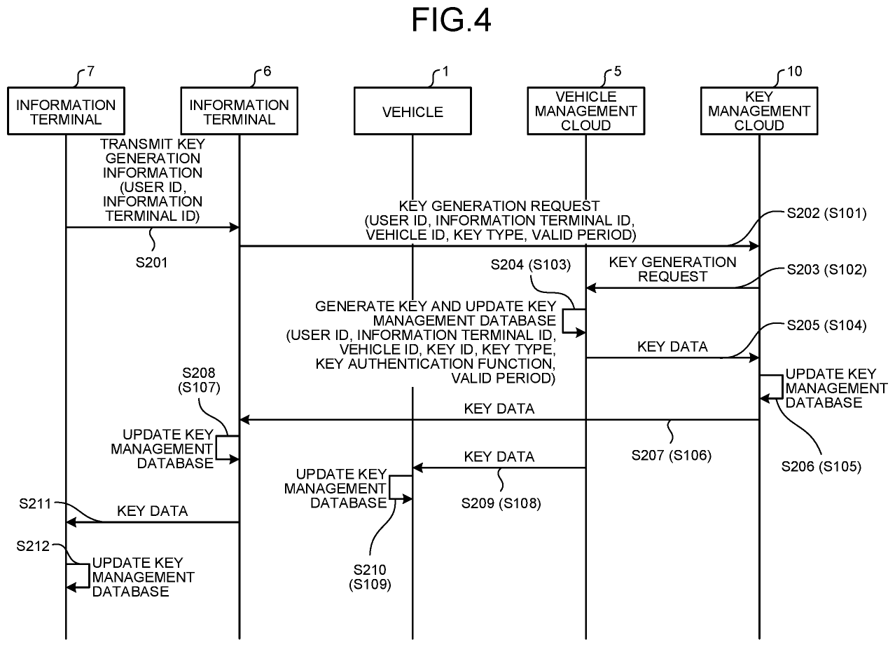

FIG. 4 is a flowchart illustrating an example of issuing a key for a temporary user. In FIG. 4, since the flow of data processing by the information terminal 6, the vehicle 1, the vehicle management cloud 5, and the key management cloud 10 is similar to that in FIG. 3, only different portions will be described. In addition, this example will be described as an example of issuing a key for the user B to temporarily use the vehicle 1 owned by the user A.

Information necessary to generate a key for the user B is transmitted from the information terminal 7 (or, an application for key management installed on the information terminal 7 may be used, and the same applies hereafter) owned by the user B who is a temporary user to the information terminal 6 of the user A who is the owner (Step S201). Here, a user ID that is information for identifying the user (user B) who is to use the new key and an information terminal ID that is information for identifying the information terminal (information terminal 7) which is to use the key to be issued are transmitted.

Next, the information terminal 6 requests the key management cloud 10 to generate a key for the user B who is a temporary user (Step S202). The request includes the vehicle ID, the key type, and the valid period in addition to the user ID that is received information for identifying the user B and the information terminal ID that is received information for identifying the information terminal 7.

Then, as with the case of FIG. 3, the key generation processing (Step S203, Step S204, Step S205, Step S206, Step S207, Step S209, and Step S210) is performed, and the information terminal 6 receives key data for the user B who is a temporary user via the communication unit 606, and updates the key management database recorded in the memory 605 (Step S208).

The information terminal 6 transmits, to the information terminal 7, key data (data set including the user ID indicating the user B, the information terminal ID indicating the information terminal 7, the vehicle ID indicating the vehicle 1, the key ID indicating the key newly issued for the user B, the key type of the key, the key authentication function for the key, and the valid period of the key, or a part of the data set) on the key newly generated for the user B (Step S211). The information terminal 7 receives the key data, stores the same in the memory 605 of the information terminal 7 as the key management database, or updates the content thereof (Step S212).

In this example, not only the user ID for identifying the user B who is a temporary user but also the information terminal ID for identifying the information terminal 7 are operated in correlation as the key data. This is because even if a third party who claims to be the user B attempts to use the vehicle 1, authentication with the vehicle 1 will not succeed without the information terminal 7. In other words, even if the key data is leaked to a third party, the key data can be used only with the information terminal 7; therefore, unauthorized use of the vehicle 1 can be prevented and safety can be improved.

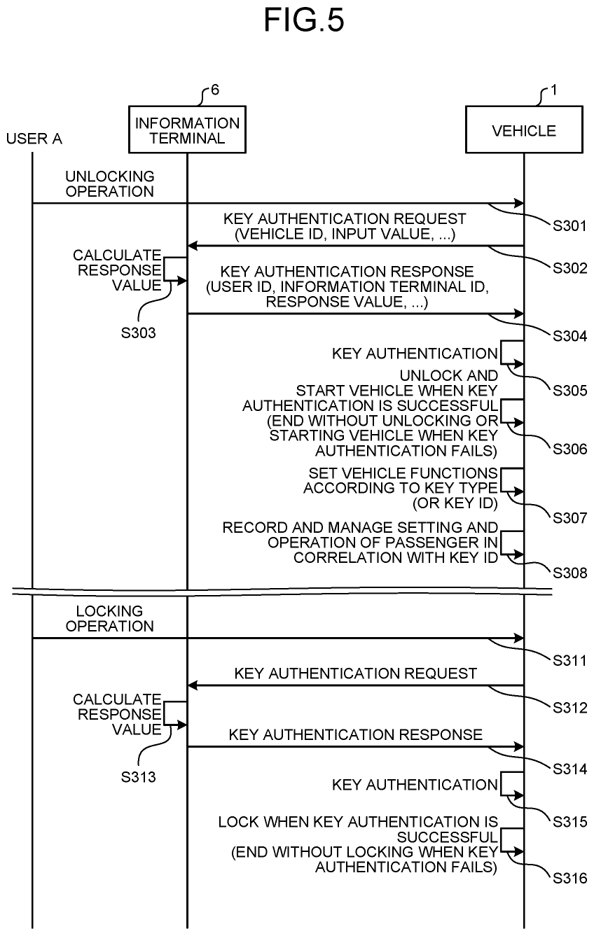

FIG. 5 is a flowchart illustrating an example from unlocking to locking. In the flowchart, for convenience of explanation, the description will be given based on a case where the user A who is the owner uses the vehicle 1 with the information terminal 6, but processing of unlocking and locking is the same even if the user is a user other than the owner, or, even if the information terminal is an information terminal owned by a person other than the owner.

The operation of unlocking the vehicle 1 is assumed to be performed in response that the user A holds a door knob of a driver seat while carrying the information terminal 6. The operation of locking the vehicle 1 is as follows: when the vehicle is in a stopped state, the user A gets off the vehicle while carrying the information terminal 6 and leaves from the vehicle 1 by a certain distance or more. The unlocking/locking operations are merely examples and may be substituted by other operations and states.

In a case where the user A holds the door knob of the driver seat of the vehicle 1 while carrying the information terminal 6, the vehicle 1 determines that the user A has performed an unlocking operation (Step S301). The fact that the user A is in the immediate vicinity of the driver seat may be determined as follows: the communication unit 108 of the vehicle 1 estimates the distance based on the reception intensity of Bluetooth (registered trademark) radio waves transmitted from the information terminal 6; UWB antennas provided as the communication unit 108 of the vehicle 1 at a plurality of sections estimate the distance to a person or the information terminal 6; or a camera provided as the sensor unit 103 of the vehicle 1 recognizes an image of a person who is in front of the door of the driver seat to identify the person. In addition, the vehicle 1 may include a sensor for detecting that a person holds the door knob of the driver seat.

In a case where the vehicle 1 determines that the door knob of the driver seat is held, a request for key authentication is transmitted with the near field communication 4 to a communication device within a predetermined distance from the driver seat (Step S302). The request may include the vehicle ID and an input value (such as a random number) to the key authentication function.

Key Authentication Request

In a case where the information terminal 6 receives the request, the information terminal 6 acquires the input value to the key authentication function included in the request, performs calculation based on the key authentication function (Step S303), and responds, to the vehicle 1, the result as a response value together with the user ID and/or the information terminal ID (Step S304).

Key Authentication Response

The vehicle 1 verifies the transmitted input value, the received response value, and the received user ID and/or information terminal ID based on the key management database recorded in the memory 107 of the vehicle 1, and determines whether the communication device is a communication device having authorized key data and/or determines which user and which information terminal has performed the unlocking operation (Step S305).

Key Authentication

Herein, a challenge and response authentication method has been described in which the vehicle 1 transmits an input value to a key authentication function to a communication device within a predetermined distance from the driver seat, and the information terminal 6 that has received the input value returns, to the vehicle 1, a result of calculation based on the key authentication function, thereby verifying whether the communication device has authorized key data to determine whether unlocking is possible; however, the present disclosure is not limited thereto.

For example, the vehicle 1 may request key data (all or a part of the user ID, the information terminal ID, the key ID, the key type, the key authentication function, and the valid period) as a key authentication request, the information terminal 6 that has received the key data may transmit the key data, and the vehicle 1 may verify the key data against the key management database managed in the memory 107 of the vehicle 1, so that key authentication is performed.

In a case where the key authentication is successful, the vehicle 1 reads a program for starting the vehicle core system from the memory 107 and causes the computing unit 106 to execute the program (Step S306). As a result, states of various devices and values of various instruments included in the vehicle 1 are confirmed. In addition, the vehicle 1 unlocks the door. In a case where the key authentication fails, the vehicle 1 does not unlock the door and does not start the vehicle 1, the processing ends here, and the subsequent processing illustrated in FIG. 5 is not performed.

In response to the core system activated, the vehicle 1 automatically sets various vehicle functions according to the key ID or the key type of the key used for unlocking (Step S307). Here, a screen of a car navigation system, a position/angle of a seat, and the like are set based on setting information for the vehicle functions for the key ID of the key used for unlocking. Details thereof will be described later.

Various vehicle functions become available, and setting changes to the various vehicle functions made by a driver or a passenger and an operation history are recorded and managed in the memory 107 of the vehicle 1 in correlation with the key ID of the key used for unlocking (Step S308). This is because the setting is automatically reflected at the time of next unlocking or at the time of starting the vehicle. For example, when the position of the seat is changed, the vehicle 1 records the position in correlation with the key ID in the memory 107. Then, in a case where the key corresponding to the key ID is used to unlock or start the vehicle next time, the computing unit 106 of the vehicle 1 automatically moves the seat to the same position as the previous position via the movable unit 101.

There are many setting items according to such physical characteristics of individual passengers and tendencies of thoughts and preferences, and it has been troublesome in the case of sharing one identical vehicle with a plurality of persons. Such a problem cannot be solved in a case where the keys of the vehicle are physically identical and are shared with a plurality of persons. However, it is assumed that when the time comes for vehicles to be shared, another person's vehicle can be used with an electronic key and the vehicle can identify a user of the vehicle by appropriately setting and controlling information included in the electronic key at the time. This probably makes it possible to realize a function of automatically adjusting the environment in the vehicle interior according to the identified user, which can provide convenience and comfort easily recognized by the user.

The processing up to this point is a vehicle operation at the time of unlocking. Subsequently, a vehicle operation at the time of locking will be described continuously with reference to FIG. 5. When the vehicle 1 is in a stopped state, the user A gets off the vehicle 1 while carrying the information terminal 6 and leaves from the vehicle 1 by a certain distance or more, whereby the vehicle 1 determines that the user A has performed a locking operation (Step S311). The distance between the user A and the vehicle 1 may be determined, as described above, based on the reception intensity of radio waves using wireless communication, distance measurement using time of flight (ToF) with a plurality of antennas, a method of image recognition and estimation of a captured image by a camera, or a combination thereof.

Key Authentication Request

In a case where the vehicle 1 determines that the operation is the locking operation, a request for key authentication is transmitted with the near field communication 4 to a communication device within a predetermined distance from the driver seat (Step S312) as with the case of the unlocking operation. The request may include the vehicle ID and an input value (such as a random number) to the key authentication function.

Key Authentication Response

In a case where the information terminal 6 receives the request, the information terminal 6 acquires the input value to the key authentication function included in the request, performs calculation based on the key authentication function (Step S313), and responds, to the vehicle 1, the result as a response value (Step S314).

Key Authentication

The vehicle 1 verifies the response value received responding to the transmitted input value, and the received user ID and/or information terminal ID based on the key management database recorded in the memory 107 of the vehicle 1, and determines whether the communication device is a communication device having authorized key data and/or determines which user and which information terminal has performed the locking operation (Step S315).

Key Authentication

In a case where the key authentication is successful, the vehicle 1 changes various vehicle functions from the stopped state to a parked state, locks all the doors, and ends the processing (Step S316). On the other hand, in a case where the key authentication fails, the vehicle 1 does not lock the doors, does not change the vehicle from the stopped state to the parked state, and ends the processing (Step S316).

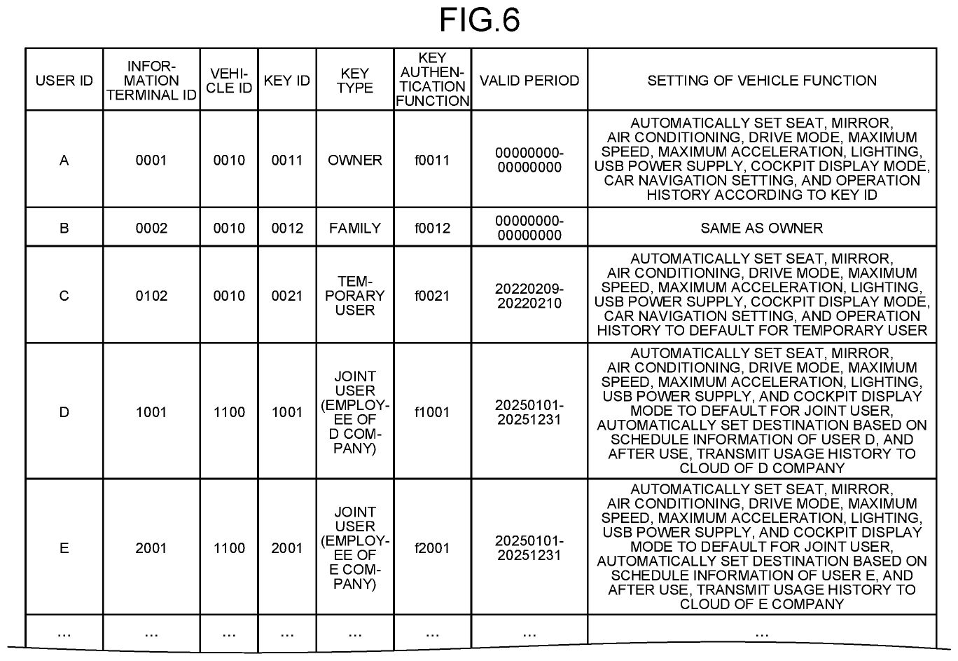

FIG. 6 is a diagram illustrating an example of key data. The description goes on to types and contents of internal data of the key management database managed by each terminal. One row in a table corresponds to one set of key data, and a plurality of sets of key data collected is referred to as the key management database in the description. As described above, the key management database including necessary information in each format is recorded and managed in the vehicle management cloud 5, the key management cloud 10, the information terminal of each user, and the memory 107 of each of the vehicles 1.

One set of key data includes information on a user ID, an information terminal ID, a vehicle ID, a key ID, a key type, a key authentication function, and a valid period.

Taking the first key as an example, the value of “user ID” indicates an owner of the key. Here, a value of “A” is taken to indicate that the owner is the user A. The value of “information terminal ID” indicates an information terminal 6 that stores the key. Here, a value of “0001” is taken to indicate that the information terminal 6 is an information terminal having an information terminal ID of “0001” (information terminal 6). The value of “vehicle ID” indicates a vehicle that is a target of the key. Here, a value of “0010” is taken to indicate that the corresponding vehicle is a vehicle having a vehicle ID of “0010” (vehicle 1). The value of “key ID” identifies the key. Here, a value of “0011” is taken to indicate that the key is a key having a key ID of “0011” (electronic key 8 of the user A).

The value of “key type” indicates a type of the key. Here, a value of “owner” is taken to indicate that the key belongs to an owner of the vehicle having the vehicle ID. The “key type” may indicate not only a value of “owner” indicating the key type of the owner of the corresponding vehicle but also a value of “family” indicating the key type of a family member of the owner of the corresponding vehicle, a value of “temporary user” indicating the key type of a temporary user of the corresponding vehicle, and a value of “joint user” indicating the key type of a person who shares the corresponding vehicle with a plurality of persons or a plurality of organizations.

In the case of a joint user, the vehicle management cloud 5 may issue different key IDs for different groups sharing the vehicle. In FIG. 6, a vehicle having a vehicle ID of “1100” is shared with an employee of the D company and an employee of the E company. The key types of the keys are the same, i.e., “joint user”, but the value of the key ID is different between the keys, i.e., “1001” for the employee of the D company and “2001” for the employee of the E company, so that a group using the vehicle can be identified.

The value of “key authentication function” is used for determining what kind of response value at the time of a key authentication response is transmitted in response to an input value at the time of a key authentication request by the key. Here, a value of “f0011” is taken to indicate that the key authentication function assigned to the key performs the calculation identified by “f0011”.

The value of “valid period” indicates a period during which the key is valid. Here, a value of “00000000-00000000” is taken to indicate that the key can be used indefinitely or that no valid period is set. In a case where the key type is “temporary user” or “joint user”, a significant value is sometimes set in “valid period”. In the example of FIG. 6, a value of “20220209-20220210” is set in the valid period for a key of which the key type is “temporary user”. This indicates year, month, and day, and means that the valid period is from Feb. 9, 2022 to Feb. 10, 2022.

Note that, here, the valid period is expressed by year, month, and day, but the present disclosure is not limited thereto, and information of hour, minute, and second may be defined in more detail, time zone information may be added, or other expression forms may be used.

“Setting of vehicle function” includes an item and a value automatically set when the vehicle is unlocked or started with the corresponding key. This information may or may not be included as a part of the key data, or, alternatively, this information may be recorded only in the key management database recorded in the memory 107 of the vehicle 1. This information includes setting information related to various vehicle functions such as a seat position of the driver seat when the user with the corresponding user ID sits on the driver seat, and whether or not to permit history display of the car navigation system. This will be described later in detail.

The information terminal of the user who unlocks the vehicle with the key management system 100 of the present disclosure performs key authentication with the vehicle using all or a part of the key data. The key data is different for each user or for each group of users (family, D company employees, etc.), which enables identifying a user that has unlocked or locked the vehicle, thereby allowing the vehicle to perform the set individual behaviors.

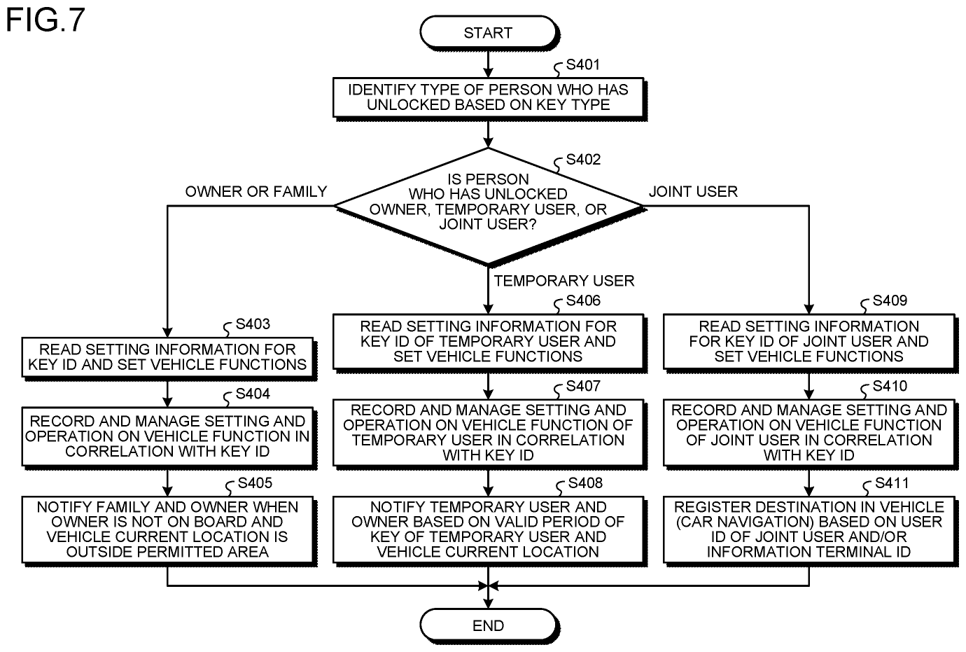

FIG. 7 is a flowchart illustrating an example of setting a vehicle function according to a key type. The processing is a detail of processing of one step corresponding to “SET VEHICLE FUNCTIONS ACCORDING TO KEY TYPE” in FIG. 5. The processing is executed by the computing unit 106 of the vehicle 1, and vehicle functions (various functions of the vehicle including the key control unit 105, the movable unit 101, the lighting unit 102, and the information input/output unit 104) are controlled according to an instruction from the computing unit 106.

In a case where the processing is started, the computing unit 106 identifies a type of a person who has unlocked the vehicle based on the key type of the key that has unlocked the vehicle (Step S401). The processing then branches into respective processing according to the type of the person who has unlocked (Step S402).

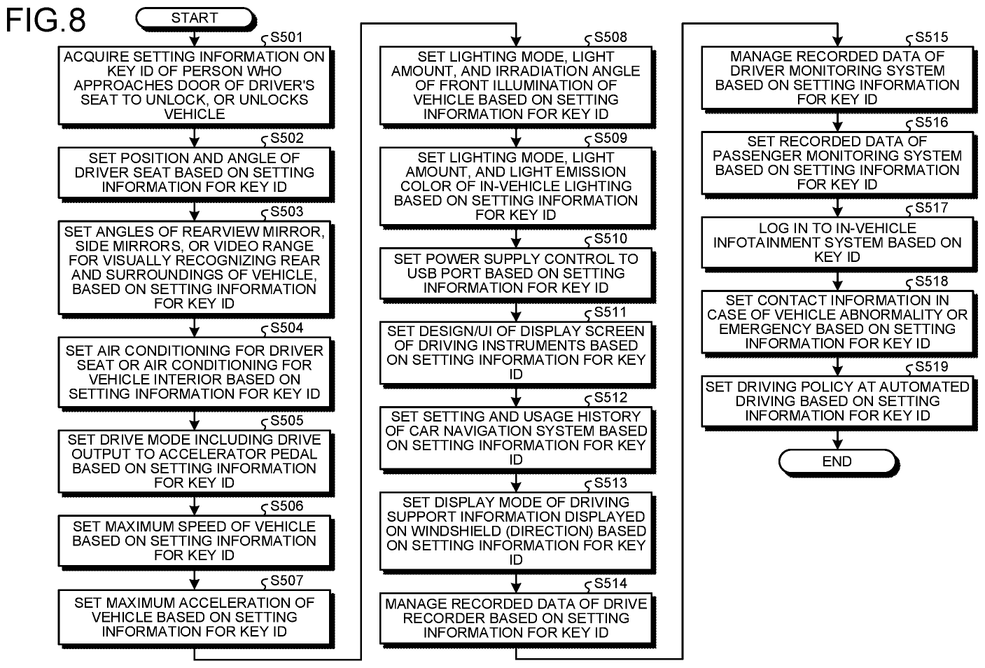

In a case where the type of the person who has unlocked is “owner” or “family”, the computing unit 106 of the vehicle 1 reads setting information corresponding to the key ID of the key used for unlocking from the key management database recorded in the memory 107 of the vehicle 1, and sets the vehicle functions based on the corresponding setting information (Step S403). Details of the processing will be described with reference to FIG. 8.

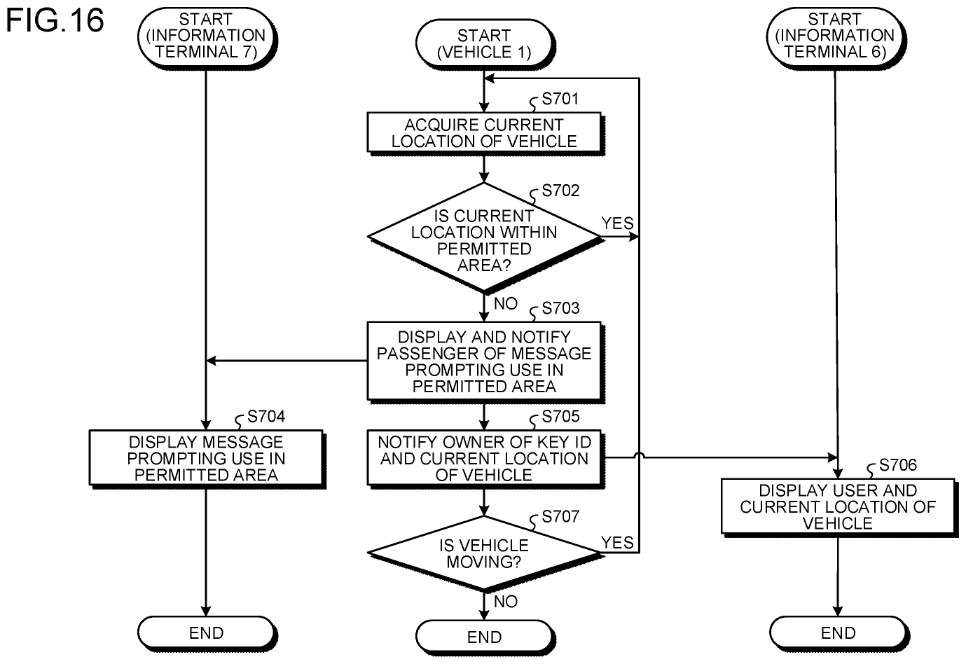

Next, a change to the setting made on the vehicle functions and a history operation by the person who has unlocked are correlated with the key ID of the key used for unlocking, and the resultant is recorded in the key management database recorded in the memory 107 of the vehicle 1 and managed (Step S404). Further, in a case where the current location of the vehicle unlocked by a family member is outside a permitted area, the fact that the vehicle is outside the permitted area is displayed in the information input/output unit 104, and the fact is notified also to an information terminal of the owner (Step S405). The processing will be described with reference to FIG. 16. This is the end of the processing for setting the vehicle functions.

The setting of the vehicle functions and the operation history are recorded in association with the key ID in this manner, which makes it possible for the owner (for example, the user A) of the key corresponding to the key ID to automatically reflect the setting that has been used so far, such as a seat and information display that match the body shape and preference of the user A when he/she gets in the vehicle next time.

In addition, even if another person (for example, the user B) having a different key ID unlocks the vehicle and changes the setting of the vehicle functions, the setting is recorded and managed as the setting information for the key ID of that person (the user B), and therefore, it is not necessary to reset the settings when the owner (the user A) of the key corresponding to the key ID gets in the vehicle next time.

Similarly, in a case where the type of the person who has unlocked is “temporary user”, the computing unit 106 of the vehicle 1 reads setting information corresponding to the key ID of the temporary user from the key management database in the memory 107 of the vehicle 1, and sets the vehicle functions based on the corresponding setting information (Step S406). Further, a change to the setting made on the vehicle functions and a history operation by the temporary user are correlated with the key ID of the key used for unlocking, and the resultant is recorded in the key management database and managed (Step S407).

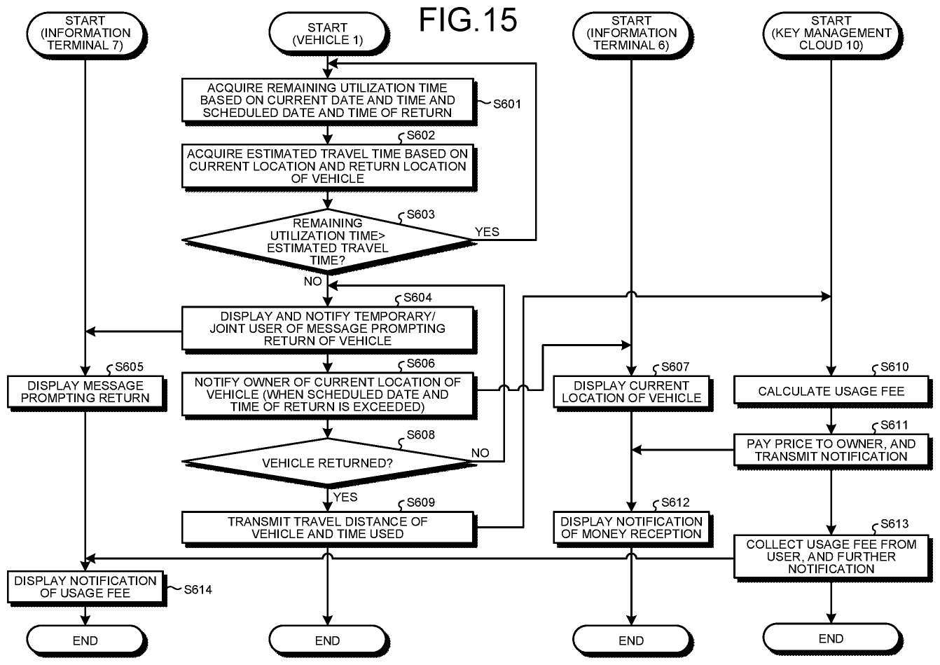

In addition, the temporary user is prompted to return the vehicle or the owner is notified of the vehicle location based on the valid period of the key data of the temporary user and the current location of the vehicle (Step S408). The processing will be described with reference to FIGS. 15 and 16. This is the end of the processing for setting the vehicle functions.

Similarly, in a case where the type of the person who has unlocked is “joint user”, the computing unit 106 of the vehicle 1 reads setting information corresponding to the key ID of the joint user from the key management database in the memory 107 of the vehicle 1, and sets the vehicle functions based on the corresponding setting information (Step S409). Further, a change to the setting made on the vehicle functions and a history operation by the joint user are correlated with the key ID of the key used for unlocking, and the resultant is recorded in the key management database and managed (Step S410).

In addition, the computing unit 106 of the vehicle 1 acquires access information (for example, a URL of a connection destination and account information) to a schedule of the joint user based on the user ID of the joint user and/or the information terminal ID, and acquires destination information from the schedule of the joint user via the communication unit 108. The computing unit 106 registers the destination information as a destination in the car navigation system equipped with the vehicle 1 (Step S411), and makes a request to start guidance. The car navigation system that has received the request starts guidance from the current location of the vehicle 1 to the destination. This is the end of the processing for setting the vehicle functions.

In the meantime, although the access information to the schedule is acquired based on the user ID of the joint user and/or the information terminal ID herein, the present disclosure is not limited thereto. For any of the owner, the family, the temporary user, and the joint user, the computing unit 106 of the vehicle 1 may acquire destination information and conditions for route selection (time and cost necessary for traveling, and requirements for indicators of a global environmental burden such as carbon emissions equivalent) from each information terminal via the communication unit 108, and may cause the car navigation system to set the information and conditions as a destination.

In the description, the processing branches based on the key type, but the present disclosure is not limited thereto, and the processing may branch based on information other than the key type (for example, the key ID) as long as the type of the person who has unlocked can be identified.

In the description, a seat on which the person who has unlocked sits is assumed to be a driver seat. However, even when the person who has unlocked sits on a seat other than the driver seat, the vehicle functions may be set similarly. Alternatively, instead of the person who has unlocked, a driver may be identified based on a face image or body type information acquired by a driver monitoring system or the like, and the processing may branch according to the type of the driver (owner, family, temporary user, joint user).

FIG. 8 is a flowchart illustrating an example of setting a vehicle function according to a key ID. This is a detail of the step “SET VEHICLE FUNCTIONS ACCORDING TO KEY TYPE” in FIG. 5 (Step S307) and the step “READ SETTING INFORMATION FOR KEY ID AND SET VEHICLE FUNCTIONS” (Step S403, Step S406, and Step S409) performed on each of the owner, the family, the temporary user, and the joint user, which is the processing immediately after the branch in FIG. 7. Similarly to FIG. 7, the processing is executed by the computing unit 106 of the vehicle 1, and various vehicle functions are controlled according to instructions from the computing unit 106.

First, setting information corresponding to a key ID of a person who has approached the door of the driver seat of the vehicle 1 and unlocked or a person who has unlocked the vehicle 1 is read from the key management database recorded in the memory 107 of the vehicle 1 (Step S501). In the following description, it is assumed that the person who has unlocked is a driver. In a case where the person who has unlocked is not a driver, that is, in a case where the person sits on a rear seat or no one drives in an autonomous driving car, the driver monitoring system or the like may individually identify a user who sits on the driver seat, and then the following processing may be performed using key data owned by the user.

The computing unit 106 of the vehicle 1 requests the movable unit 101 to set the position of the seat of the driver seat, a connection angle between the seat portion and the backrest portion, and a connection angle between the backrest portion and the headrest portion based on the setting information for the key ID of the key used by the person who has unlocked (Step S502). Thus, sheet settings according to the body type of the person who has unlocked are automatically made.

The computing unit 106 of the vehicle 1 instructs the movable unit 101 to set the angles and the curvatures of a rearview mirror and side mirrors based on the setting information for the key ID of the key used by the person who has unlocked (Step S503). The computing unit 106 of the vehicle 1 also requests the information input/output unit 104 to set a target area to be shown on a monitor image for visually recognizing the rear and surroundings of the vehicle and a zoom magnification of the monitor image. Thereby, mirror settings are automatically made so that the person who has unlocked can easily see the mirrors.

The computing unit 106 of the vehicle 1 requests the vehicle interior space control unit 109 to set air conditioning for the driver seat (temperature, humidity, air volume, wind direction, and presence or absence of air purifying function) and/or air conditioning for the entire vehicle interior based on the setting information for the key ID of the key used by the person who has unlocked (Step S504). Thus, air conditioning settings according to the preference of the person who has unlocked are automatically made.

The computing unit 106 of the vehicle 1 requests the movable unit 101 to set a drive mode including the correlation of the drive output with respect to an amount of depression of an accelerator pedal based on the setting information for the key ID of the key used by the person who has unlocked (Step S505). Thus, drive mode settings according to the preference of the person who has unlocked are automatically made.

The computing unit 106 of the vehicle 1 requests the movable unit 101 to set the maximum speed of the vehicle based on the setting information for the key ID of the key used by the person who has unlocked (Step S506). This enables automatically limiting the maximum speed that can be set by the vehicle according to the person who has unlocked. In a case where the key type is a temporary user, and the vehicle interior space is lent out only in a parked or stopped state without moving the vehicle, the maximum speed may be preset to 0 Km/h, and the key data may be passed to the temporary user.

The computing unit 106 of the vehicle 1 requests the movable unit 101 to set the maximum acceleration of the vehicle based on the setting information for the key ID of the key used by the person who has unlocked (Step S507). This enables automatically limiting the maximum acceleration that can be set by the vehicle according to the person who has unlocked.

The computing unit 106 of the vehicle 1 requests, based on the setting information for the key ID of the key used by the person who has unlocked, the lighting unit 102 to set a lighting mode of lighting for illuminating the front of the vehicle according to the weather (whether to use fog lamps together at the time of dense fog or snowfall, etc.), lighting conditions according to the illuminance around the vehicle (at what illuminance level the lighting should be turned on, etc.), light intensity when lighting is turned ON, a lighting angle (distance to the ground illuminated by the lighting), and a light emission color (Step S508 and Step S509). Thus, lighting settings according to the preference of the person who has unlocked are automatically made.

The computing unit 106 of the vehicle 1 requests the vehicle interior space control unit 109 to set the presence or absence of power supply to the USB port provided in the vehicle, the maximum current amount, and the supported version of the USB standard based on the setting information for the key ID of the key used by the person who has unlocked (Step S510). Thus, settings for USB power supply according to the person who has unlocked are automatically made. In a case where the key type corresponds to a temporary user, and the vehicle interior space is lent out only in a parked or stopped state without moving the vehicle 1, if the key is a key for which power supply to the USB port is permitted, there is an advantage that a device compatible with USB power supply is easily used in the vehicle interior.

The computing unit 106 of the vehicle 1 requests the information input/output unit 104 to set a screen design including driving instruments displayed on a monitor in the vehicle interior including a cockpit (design and layout of instruments, content of information displayed, and display form thereof), and a user interface (touch operation enabled/disabled, voice operation enabled/disabled, gesture operation enabled/disabled, and the like) based on the setting information for the key ID of the key used by the person who has unlocked (Step S511). Thus, information display settings according to the preference of the person who has unlocked are automatically made.

The computing unit 106 of the vehicle 1 requests the information input/output unit 104 to set the presence or absence of a history display of destination settings and display settings of route-related information displayed on the monitor in the vehicle interior including the car navigation system based on the setting information for the key ID of the key used by the person who has unlocked (Step S512). Thus, route information is automatically displayed in a display form preferred by the person who has unlocked.

This makes it possible to automatically make settings in consideration of privacy, such as not displaying, to a temporary user or the like, a destination set in the past by the owner of the vehicle or home location information. This is likely to be a particular concern for the owner and the user to use a shared vehicle; and accordingly it is desirable that automatic control is performed according to a key used for unlocking.

The computing unit 106 of the vehicle 1 requests the information input/output unit 104 to set the presence/absence of display of driving support information displayed in a space in the forward direction seen from the person who has unlocked (driver) or on a transparent plate-like display unit such as a windshield or a head-up display, and a display mode thereof based on the setting information for the key ID of the key used by the person who has unlocked (Step S513). Thus, settings for driving support information according to the preference of the person who has unlocked are automatically made.

The computing unit 106 of the vehicle 1 requests the information input/output unit 104 to set whether or not to permit access to or whether or not to permit reproduction of recorded data such as a drive recorder that records video and sounds around the vehicle and inside the vehicle during driving based on the setting information for the key ID of the key used by the person who has unlocked (Step S514). This allows the person who has unlocked not to automatically view the video of the drive recorder for a different person who has unlocked. For example, it is possible to prevent such privacy issues that a person who has unlocked corresponding to a temporary user of the key type views the video and audio of the drive recorder at the time when the owner drives the vehicle.

The computing unit 106 of the vehicle 1 requests the information input/output unit 104 to set whether or not to permit access to or whether or not to permit reproduction of recorded data such as the driver monitoring system that records video and sounds inside the vehicle during driving or records analysis data acquired from the analysis thereof based on the setting information for the key ID of the key used by the person who has unlocked (Step S515). This allows the person who has unlocked not to automatically view or read the video of the driver monitoring system or analysis data thereof for a different person who has unlocked. For example, it is possible to prevent such privacy issues that a person who has unlocked corresponding to a temporary user of the key type views recorded data of the driver monitoring system at the time when the owner drives the vehicle.

The computing unit 106 of the vehicle 1 requests the information input/output unit 104 to set whether or not to permit access to or whether or not to permit reproduction of recorded data such as a passenger monitoring system that records video and sounds inside the vehicle during driving or records analysis data acquired from the analysis thereof based on the setting information for the key ID of the key used by the person who has unlocked (Step S516). This allows the person who has unlocked not to automatically view or read the video of the passenger monitoring system or analysis data thereof for a different person who has unlocked. For example, it is possible to prevent such privacy issues that a person who has unlocked corresponding to a temporary user of the key type views recorded data of the passenger monitoring system at the time when the owner drives the vehicle.

The computing unit 106 of the vehicle 1 requests the information input/output unit 104 to make settings for enabling automatic login to an infotainment system in which a person enjoys not only the driving-related information but also entertainment content irrelevant to driving based on the setting information for the key ID of the key used by the person who has unlocked (Step S517). Thus, information display settings according to the preference of the person who has unlocked are automatically made. For example, this makes it possible to realize that a top menu screen of a video distribution service contracted by the person who has unlocked is displayed in the infotainment system immediately after he/she gets in the vehicle.

The computing unit 106 of the vehicle 1 requests the information input/output unit 104 to set contact information for an emergency contact in preparation for a case where it is determined that there is a serious abnormality in the vehicle which makes it difficult to drive or a case where it is determined that an emergency situation arises such as the vehicle being involved in an accident based on the setting information for the key ID of the key used by the person who has unlocked (Step S518). This allows an emergency contact to be automatically made when it is determined that there is an abnormality or an emergency. The contact information for emergency contact includes at least one of a vehicle insurance company, a vehicle sales company, a police station, a fire department, and contact information designated by the person who has unlocked.

In the meantime, in a case where it is determined that there is an abnormality or an emergency, the computing unit 106 of the vehicle 1 may cause a device that senses the state of the vehicle interior, such as the drive recorder, the driver monitoring system, or the passenger monitoring system, to perform safety confirmation or state confirmation of the passenger. In addition, the sensing data and the analysis data may be included in the emergency contact. For example, in a case where it is determined that an accident has occurred, a video of the inside and outside of the vehicle immediately before and after the accident, and a result of sensing life activity information of a driver and a passenger (heart rate, respiratory rate, body temperature, blood pressure, and the like) are notified to the fire department together with the vehicle location information, so that the fire department and related organizations can take a quick response.

The computing unit 106 of the vehicle 1 requests the movable unit 101 to set a driving policy applied at the time of automated driving based on the setting information for the key ID of the key used by the person who has unlocked (Step S519). Thus, automated driving control according to the preference of the person who has unlocked are automatically set. The driving policy at the time of automated driving includes at least one of a reference of a driving speed with respect to a speed limit for each road section, acceleration control, deceleration control, vehicle control at the time of turning left/right, a distance between vehicles, a condition of a lane change, and a traffic priority of a moving object (person, bicycle, etc.) around the vehicle.

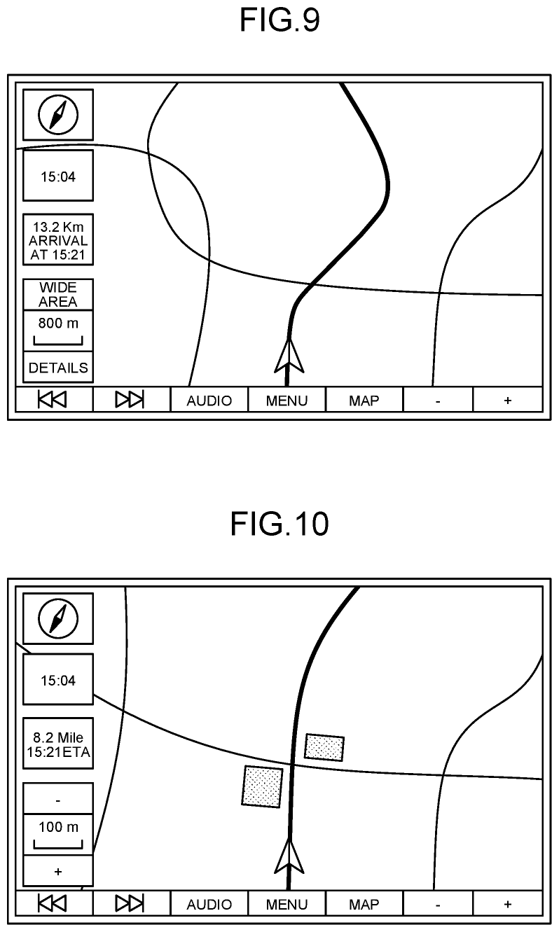

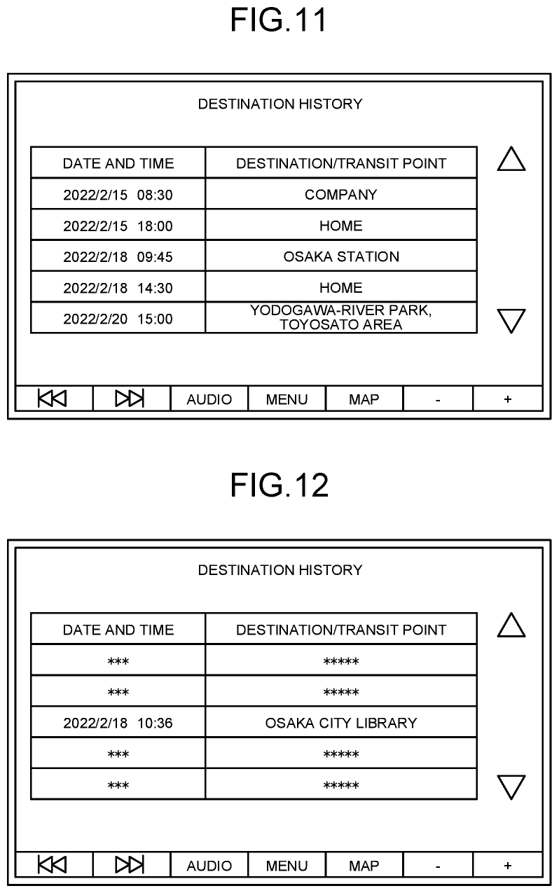

FIGS. 9 and 11 are diagrams illustrating an example of a screen of the car navigation system displayed for an owner. FIGS. 10 and 12 are diagrams illustrating an example of screens of the car navigation system displayed for a temporary user or a joint user. The diagrams illustrate an example of screen display after execution of processing of the step “SET VEHICLE FUNCTIONS ACCORDING TO KEY TYPE” in FIG. 5 (Step S307) and the step “READ SETTING INFORMATION FOR KEY ID AND SET VEHICLE FUNCTIONS” (Step S403, Step S406, and Step S409) performed on each of the owner, the family, the temporary user, and the joint user, which is the processing immediately after the branch in FIG. 7, and the settings of (the car navigation system of) the information input/output unit 104 are changed from the computing unit 106 of the vehicle 1 according to the key type and/or the key ID.

FIG. 9 illustrates a screen displaying a map of the area around the vehicle on the car navigation system of the owner. The display at the left end of the screen, i.e., 13.2 Km and arrival at 15:21, indicates that the destination is 13.2 Km away and the estimated time of arrival at the destination is 15:21. Here, the unit of the distance is m. In addition, the scale of the map of the area around the vehicle is displayed as 800 m at the left end of the screen, and the user interface for enlargement/reduction of the map uses a method of touching “wide area” or “details” with a finger.

On the other hand, the scene of FIG. 10 is the same as that of FIG. 9, but FIG. 10 illustrates an example of screen display for a case where the vehicle is unlocked (or the vehicle core system is activated) with the key type (or the key ID) of a temporary user or a joint user. FIG. 10 is different from FIG. 9 in that the unit is different, e.g., the distance to the destination is not 13.2 Km but 8.2 Mile, in that the language is different, e.g., 15:21 ETA is used instead of 15:21 arrival, in that language dependency is different, e.g., “−” and “+” marks are used for the enlargement/reduction button of the map instead of “wide area” or “details”, and in that the scale of the map is different, e.g., 100 m is shown instead of 800 m. Since the scale of the map is changed, the map is zoomed up and a detailed map of the area around the vehicle is displayed in FIG. 10.

The differences in settings of the screen display of the car navigation system between FIGS. 9 and 10 is due to a difference in the key type (or key ID) of the key used for unlocking. In this way, according to the key type (or key ID) of the key used for unlocking, in the case of the owner, the map is displayed according to the settings that the owner usually uses, and the map is displayed according to default settings in the case of a temporary user or a joint user.

In addition, even in a case where the settings for map display are changed, the change is recorded in the key management database in correlation with the key ID of the key of the person who has unlocked himself, who has changed the settings; therefore, there is an advantage that other users having different key IDs are not affected.

FIG. 11 is a diagram illustrating an example of a screen of the car navigation system displayed for the owner. The screen displays a history of destination settings which is a usage history of the car navigation system. The history screen can be displayed by selecting a “MENU” button at the bottom of the screen and selecting a “destination history” button (not illustrated).

In the example of FIG. 11, as the destination history, when the owner has set a destination, and where the owner has set as the destination or as a transit point are displayed as a list. Thus, the owner can easily select the same destination in his/her past usage history.

FIG. 12 is a diagram illustrating an example of a screen of the car navigation system displayed for a temporary/joint user. The screen can be displayed by the same operation as in FIG. 11.

In the example of FIG. 12, as the destination history, when the temporary/joint user who has unlocked has set a destination, and where that temporary/joint user has set as the destination or as a transit point are displayed. Portions not corresponding to the subject user's history are not displayed, or are displayed with an asterisk “*****” so that the content is not recognizable. Thus, the temporary/joint user can easily select the same destination in his/her past usage history.

The differences in settings of the screen display of the car navigation system between FIGS. 11 and 12 is due to a difference in the key type (or key ID) of the key used for unlocking. In this way, according to the key type (or key ID) of the key used for unlocking, in the case of the owner, the owner's history that the owner usually uses is displayed, and, in the case of a temporary user or a joint user, none of the histories are displayed or only the history of the subject user is displayed. The display of the information related to the usage history of the car navigation system is changed according to the key type (or the key ID) of the key used for unlocking in this manner, which makes it possible to prevent another person from viewing the usage history of the subject user and to protect privacy. The function is probably useful particularly in a case where the vehicle 1 is shared with another person.

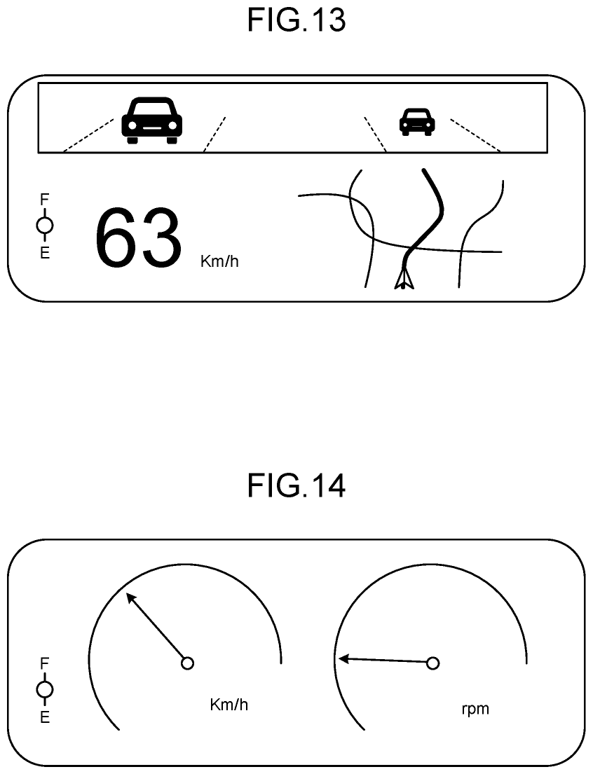

FIG. 13 is a diagram illustrating an example of a screen of a cockpit displayed for the owner. FIG. 14 is a diagram illustrating an example of a screen of a cockpit displayed for a temporary/joint user. The diagrams illustrate an example of screen display after execution of processing of the step “SET VEHICLE FUNCTIONS ACCORDING TO KEY TYPE” in FIG. 5 (Step S307) and the step “READ SETTING INFORMATION FOR KEY ID AND SET VEHICLE FUNCTIONS” (Step S403, Step S406, and Step S409) performed on each of the owner, the family, the temporary user, and the joint user, which is the processing immediately after the branch in FIG. 7, and the settings of (a cockpit system of) the information input/output unit 104 are changed from the computing unit 106 of the vehicle 1 according to the key type and/or the key ID.

FIG. 13 is a cockpit screen for the owner. The cockpit screen displays, on the upper side, a high viewing angle video of the rear of the vehicle processed so that the video from (one or more rear cameras of) the sensor unit 103 is easy to be visually recognized, on the lower left side, a remaining amount of gasoline or battery and a current vehicle speed, and on the lower right side, a map and a route of the area around the vehicle. They are display designs individually set by the owner.

FIG. 14 is a cockpit screen for a temporary user or a joint user. The cockpit screen displays, on the lower left side, a remaining amount of gasoline or battery, at the left center, a speedometer, and at the right center, a tachometer. They are display designs set by default for a temporary user or a joint user.

The differences in settings of the screen display of the cockpit system between FIGS. 13 and 14 is due to a difference in the key type (or key ID) of the key used for unlocking. In this way, according to the key type (or key ID) of the key used for unlocking, in the case of the owner, driving instruments and the like are displayed in the display design of the cockpit that is set and usually used by the owner, and, in the case of a temporary user or a joint user, the driving instruments and the like are displayed according to a default display design. The information to be displayed on the cockpit system and the display format are changed according to the key type (or key ID) of the key used for unlocking in this manner, which makes it possible to adjust to the preference of the subject user and prevent another person from being affected when he/she drives.

FIG. 15 is a flowchart illustrating an example of notification processing regarding the vehicle 1 that is being used by a temporary user or a joint user. In the example, the description is provided assuming that an information terminal owned by the owner (user A) of the vehicle 1 is the information terminal 6, and an information terminal owned by a user (user B) who temporarily uses or shares the vehicle 1 is the information terminal 7. The processing is an example of specific processing of the step “NOTIFY TEMPORARY USER AND OWNER BASED ON VALID PERIOD OF KEY OF TEMPORARY USER AND VEHICLE CURRENT LOCATION” performed on a temporary user in FIG. 7.

Note that, in FIG. 7, the step is not illustrated in the processing for a joint user; however, the step is applicable to the joint user similarly to a temporary user.

Here, a scheduled date and time at which the temporary user starts to borrow the vehicle is set as a scheduled date and time of pick-up, and a scheduled date and time at which the vehicle is returned is set as a scheduled date and time of return. The scheduled date and time of pick-up and the scheduled date and time of return are handled as one set of key data for the temporary user or the joint user (not illustrated in FIG. 6). The valid period of the key owned by the temporary user or the joint user is set to include the time indicated in the scheduled date and time of pick-up and the scheduled date and time of return. For example, the start date and time of the valid period is the same as the scheduled date and time of pick-up, and the end date and time of the valid period may be set to a time obtained by adding a predetermined time (3 hours or 24 hours, for example) to the scheduled date and time of return.

The computing unit 106 of the vehicle 1 acquires the remaining utilization time based on the current date and time and the scheduled date and time of return set in the key used for unlocking (Step S601). Further, the computing unit 106 of the vehicle 1 calculates, based on the current location of the vehicle 1 and a return location indicating a location where the vehicle 1 should be returned, an estimated travel time required for movement from the current location to the return location, or acquires the estimated travel time by cooperating with an external service via the communication unit 108 (Step S602). If the remaining utilization time is longer than the estimated travel time, then it is determined that the vehicle 1 is to be returned by the scheduled date and time of return, and the processing returns to Step S601 (Step S603: Yes). If the remaining utilization time is not longer than the estimated travel time, then it is determined that the vehicle 1 may be returned late, and the processing proceeds to the next processing (Step S603: No).

The computing unit 106 of the vehicle 1, which has detected that the vehicle 1 may be returned later than the scheduled date and time of return, notifies the temporary user or the joint user (user B) using the vehicle 1 of a message prompting the user to return the vehicle via the information input/output unit 104 of the vehicle 1 (Step S604). For example, the message may be displayed in the cockpit system, which is one of the information input/output units 104.

Further, the computing unit 106 of the vehicle 1 transmits a message for prompting the user B to return the vehicle 1 to the information terminal 7 (identified based on the information terminal ID of the key currently used) owned by the user B who currently uses the vehicle 1 via the communication unit 108 of the vehicle 1. Thereby, the information terminal 7 can receive the message and prompt the user B who is the owner of the information terminal 7 to return the vehicle via the video/audio output unit 602 of the information terminal 7 (Step S605).

Since there is a risk that the vehicle 1 will not be returned at the scheduled date and time of return, the computing unit 106 of the vehicle 1 notifies the information terminal (information terminal 6) of the owner (user A) of the current location of the vehicle 1 via the communication unit 108 (Step S606). Upon receiving the notification, the information terminal 6 notifies the user A, who is the owner, of the current vehicle location information via the video/audio output unit 602 (Step S607). The vehicle location information may be notified after being processed so as to respect privacy, as described with reference to FIG. 16. Until the vehicle 1 is returned, the computing unit 106 of the vehicle 1 keeps sending the current user (user B) of the vehicle 1 the message for prompting him/her to return the vehicle 1, and keeps sending the owner (user A) of the vehicle 1 the current location information of the vehicle 1 (Step S608: No in the branch processing as to whether the vehicle 1 has been returned).

Note that the present disclosure is not limited thereto, and the notification of the current location of the vehicle to the owner (user A) may be made from the computing unit 106 of the vehicle 1 via the communication unit 108 only in a case where the vehicle 1 is not returned even after the scheduled date and time of return.

In response to the vehicle 1 returned (Step S608: Yes in the branch processing as to whether the vehicle 1 has been returned), the computing unit 106 of the vehicle 1 counts the total distance traveled with the key of the user, the route information, and the total utilization time from the start of actual use to the end of use, and transmits the result to the key management cloud 10 via the communication unit 108 (Step S609). The key management cloud 10 receives this and calculates the usage fee in accordance with a usage fee system (Step S610). Then, a price for lending the vehicle 1 is separately calculated and paid to the owner (user A) of the vehicle 1 (Step S611).

Further, details of the payment are transmitted to the information terminal 6. The Information terminal 6 displays the details of the payment on the video/audio output unit 602 (Step S612). Thereby, the owner (user A) checks the price for lending the vehicle 1.

Further, the key management cloud 10 collects a usage fee from the user (user B) who has used the vehicle 1 (Step S614). Further, a notification of the usage fee is transmitted to the information terminal (information terminal 7) of the user (user B). The Information terminal 7 displays the notification of the usage fee on the video/audio output unit 602. Thereby, the user (user B) checks the usage fee for using the vehicle 1.

In the meantime, it is assumed that payment information (for example, user identification information, credit card information, and the like in an electronic settlement service) of the owner and the user of the vehicle is recorded and managed in the memory 1002 of the key management cloud 10.

FIG. 16 is a flowchart illustrating an example of notification processing in the vehicle 1 that is being used by a family/temporary/joint user. The processing is an example of specific processing of the step “NOTIFY FAMILY AND OWNER WHEN OWNER IS NOT ON BOARD AND VEHICLE CURRENT LOCATION IS OUTSIDE PERMITTED AREA” (Step S405) in FIG. 7.

Note that, in FIG. 7, the step is not illustrated in the processing for a temporary user or a joint user; however, the step is applicable to the temporary user and the joint user similarly to a family. Further, the permitted area indicates information on area permitted to travel, and the key type is handled as one set of key data of a family, a temporary user, or a joint user (not illustrated in FIG. 6).

Here, the description is given on the assumption that the information terminal of the user A who is the owner of the vehicle 1 is the information terminal 6 and the information terminal of the user of the vehicle 1 is the information terminal 7.

In a case where the key type of the key used for unlocking is “family”, “temporary user”, or “joint user”, or in a case where the user ID or the key ID of the key used for unlocking indicates a key for a child or an elderly person, the computing unit 106 of the vehicle 1 performs the following processing.

First, the computing unit 106 of the vehicle 1 acquires the current location of the vehicle 1 (Step S701). The computing unit 106 of the vehicle 1 then determines whether the current location is within a permitted area for the corresponding user. If the current location is within the permitted area, then the processing returns to the processing of Step S701 (Step S702: Yes). On the other hand, if the current location is not within the permitted area, then the processing proceeds to the next processing (Step S702: No).

The computing unit 106 of the vehicle 1 displays, on the information input/output unit 104, a message prompting the user of the vehicle 1 to use the vehicle 1 within the permitted area (Step S703). For example, the message may be displayed in the cockpit system, which is one of the information input/output units 104. Further, the computing unit 106 of the vehicle 1 transmits a message for prompting the user B to use the vehicle 1 within the permitted area to the information terminal 7 (identified based on the information terminal ID of the key currently used) owned by the user B who currently uses the vehicle 1 via the communication unit 108 of the vehicle 1.

Thereby, the information terminal 7 can receive the message and prompt the user B who is the owner of the information terminal 7 to use the vehicle 1 within the permitted area via the video/audio output unit 602 of the information terminal 7 (Step S704).

Further, the computing unit 106 of the vehicle 1 transmits the key ID of the key currently used and the current location information of the vehicle 1 to the information terminal 6 of the user A who is the owner of the vehicle 1 via the communication unit 108 (Step S705). The information terminal 6 receives the key ID and the current location information, and displays the user (identified from the key ID, the user ID corresponding to the key ID, or the information terminal ID) of the vehicle 1 and the current location information on the video/audio output unit 602 (Step S706). In this manner, the user A is informed of the user and the current location of the vehicle 1.

Here, the vehicle 1 notifies the current location information, but in particular, in the case of a shared car or the like, privacy protection of an unspecified user (user B or the like, for example) is sometimes an issue. Accordingly, the vehicle 1 may reduce the resolution of the current location information to transmit the current location information to the information terminal 6.

For example, the current location of the vehicle 1 may be roughly expressed in units of areas having a certain size such as prefectures and municipalities in which the vehicle 1 is currently located, may be expressed by an estimated travel time (the unit may be 1 hour, 10 minutes, 1 minute, or the like) to the scheduled return location instead of the location information, may be expressed by an estimated travel distance (the unit may be 10 Km, 1 Km, or the like) to the scheduled return location, or may not be quantitatively expressed.

For example, the current location information may be replaced with an expression with a reduced resolution so that the current location cannot be identified, such as “still going to take a long time”, “still going to take some time”, “going to take one hour or more”, “distance enough to take one hour or more”, “going to take approximately two hours or less”, or “distance enough to travel within approximately two hours”.

The computing unit 106 of the vehicle 1 repeatedly performs the above processing when the vehicle 1 is moving or while the sensor unit 103 detects that the user is in the vehicle 1 (Step S707: Yes). If the vehicle is not moving, or if the vehicle is locked in a parked state (Step S707: No), then the processing ends.

As described above, the processing of FIG. 16 is processing for notifying the owner in a case where the vehicle 1 used by a family, a temporary user, a joint user, a child, or an elderly person travels beyond the permitted area. For example, in a case where the vehicle is an autonomous driving vehicle, the owner can be notified that a child or an elderly person is traveling to a place far beyond the owner's expectation or in a dangerous region. Alternatively, the owner can be notified that a temporary user or a joint user is traveling beyond a predetermined travel area.

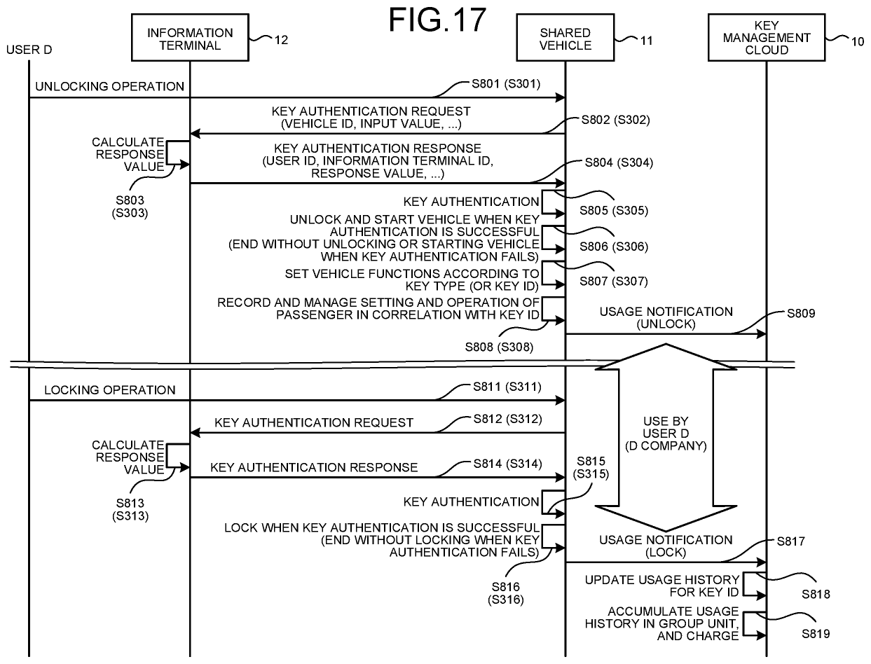

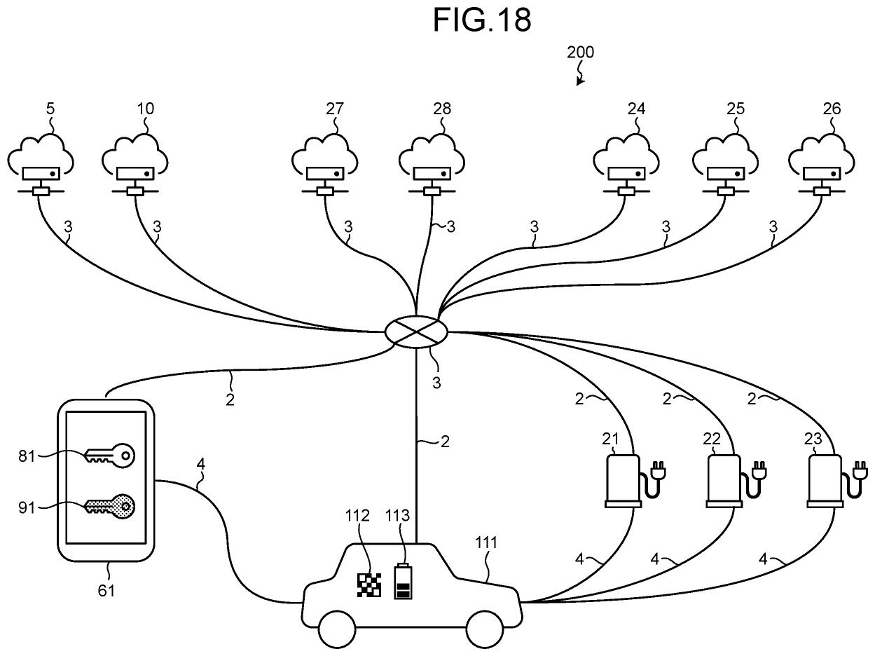

FIG. 17 is a flowchart illustrating an example of a usage notification to a joint user. In the case of a joint user, as illustrated in FIG. 6, a plurality of groups, such as an employee of D company and an employee of E company, may use one identical vehicle (having a vehicle ID of “1100”). In such a joint use, a plurality of groups can share the maintenance cost of the vehicle and the economic efficiency is high, but if a system for charging according to the degree of use is to be operated, the management is troublesome.

In this example, a method is considered for dividing the maintenance cost of the shared vehicle according to the degree of use for each group using the key ID (alternatively, the user ID, the information terminal ID, the key type, and the like) of the key data. The description is given of processing in which a user D (having a user ID of “D”) uses a shared vehicle 11 (having a vehicle ID of “1100”) using an information terminal 12 (having an information terminal ID of “1001”).

Since the processing performed among the user D, the information terminal 12, and the shared vehicle 11 herein is the same as the processing performed among the user A, the information terminal 6, and the vehicle 1 described in FIG. 5, different parts will be mainly described. The hardware configuration of the shared vehicle 11 is similar to the hardware configuration of the vehicle 1. Accordingly, as for the hardware configuration of the shared vehicle 11, refer to the description of the hardware configuration of the vehicle 1 described above.

Immediately after the user D successfully unlocks the shared vehicle 11, the computing unit 106 of the shared vehicle 11 transmits a usage notification (unlocking) indicating that the vehicle has been unlocked and started to be used by the user D (information terminal 12) to the key management cloud 10 via the communication unit 108 (Step S809). This is handled as the start of use of the shared vehicle 11 by the user D or the company D.

Immediately after the user D successfully locks the shared vehicle 11, the computing unit 106 of the shared vehicle 11 transmits a usage notification (locking) indicating that the vehicle has been locked and finished to be used by the user D (information terminal 12) to the key management cloud 10 via the communication unit 108 (Step S817). This is handled as the end of use of the shared vehicle 11 by the user D or the company D.

The key management cloud 10 records the usage history information for the key ID (Step S818). Further, the key management cloud 10 accumulates the usage history for each group (company D in this example) contracted in a predetermined time unit (once a month, for example), calculates the usage fee, and charges the usage fee to the group (Step S819).

As described above, in a case where one or more vehicles 1 are shared with one or more groups, calculating the usage fee according to the usage history for each group is simplified and accurate by acquiring status of use of each key by the key management cloud 10.

Although the example in which the vehicle functions are set according to the key ID is described above, face authentication may be used instead of the key ID. Face data on the owner, the family, the temporary user, and the joint user is stored in advance in a server or a memory mounted on the vehicle. A configuration is possible in which face information of a person who has unlocked is acquired by a driver monitoring sensor installed near the driver seat, and the face information is checked against face data stored in a server or the memory 107 mounted on the vehicle 1 to determine whether the person who has unlocked is the owner, the family, the temporary user, or the joint user, and vehicle functions matching the preference of the person who has unlocked are set. In the case of setting the vehicle functions by the face authentication, a physical key instead of the information terminal may be used for unlocking.

Another configuration is possible in which face information of passengers other than the person who has unlocked is acquired by an in-vehicle monitoring sensor for identifying the passengers in the vehicle, the passenger in each seat is identified by checking the face information against face data stored in the server or the memory 107 mounted on the vehicle 1, and the vehicle functions are set according to each passenger.

The in-vehicle monitoring sensor may be installed near the room mirror or near the center of the ceiling. Alternatively, for example, in the case of the rear seat, the in-vehicle monitoring sensor may be installed near the front when viewed from each seat, such as behind the backrest or behind the headrest of the front seat.

In a case where a check by the face authentication cannot be performed, it is determined that the user is none of the owner, the family, the temporary user, and the joint user, and the vehicle functions may be set to predetermined default settings, or, alternatively, an alert notification indicating that a user whose face data is not registered is on board is sent to the information terminal of the owner.

The key management system 100 can not only change the key of the vehicle 1 from a physical key to an electronic key, but also set the vehicle functions for each user, which makes it possible to record and restore settings for the vehicle functions that the user prefers in a vehicle shared with a plurality of people. In addition, a mechanism for observing a lending period and a travel permitted area is introduced for a temporary vehicle user, which can provide an effect of preventing a problem related to vehicle sharing with a third party. As the use of vehicles expands from ownership to sharing, it is expected that the key management system 100 of the present disclosure can contribute to the promotion and development of the use.

### Second Embodiment

The description goes on to an aspect in which an identical user uses a shared car with a plurality of electronic keys in more detail. The description of the same embodiment as described above is omitted.

A control method according to the second embodiment is a control method in a first computer that can access at least one database managing vehicle information on a plurality of vehicles and a plurality of electronic keys corresponding to the plurality of vehicles, the control method includes receiving, from a first terminal of a first user via a network, first authentication information including a first electronic key that the first user can use and a first vehicle ID for identifying a first vehicle that the first user requests to use, determining that the first authentication information is valid based on the first electronic key, the first vehicle ID, and the at least one database, and then transmitting, to the first vehicle via the network, a first permission signal indicating that the first user is permitted to use the first vehicle, after the first user starts using the first vehicle, acquiring first use information indicating a status of use of the first vehicle from the first vehicle via the network, transmitting, in a caser where the first electronic key is a first company key correlated with a first business entity that the first user belongs to, at least a part of the first use information to a second computer related to the first business entity via the network, and not transmitting, in a case where the first electronic key is a first personal key of the first user, the at least a part of the first use information to the second computer.

FIG. 18 is a block diagram illustrating an example of the overall configuration of a key management system 200 according to an embodiment of the present disclosure. Here, a user C manages (stores) a plurality of electronic keys using a car sharing application installed on an information terminal 61 (for example, a smartphone or the like) used by the user C. One of the electronic keys is a company electronic key 81 used by the user C for an activity according to the purpose of a corporation or organization to which the user C belongs, and the other is a personal electronic key 91 used by the user C for an activity according to the individual's personal purpose.

The user C selects one electronic key from among the plurality of electronic keys managed by the information terminal 61 according to the intended use. That is, the electronic key is one selected from among the plurality of electronic keys in the information terminal 61.

The user C is an example of the first user. The information terminal 61 is an example of the first terminal. The corporation or organization to which the user C belongs is an example of a business entity. The business entity may be read as a company. The company electronic key 81 is an example of the first company key. The personal electronic key 91 is an example of the first personal key. The electronic key is an example of the first electronic key.

A vehicle 111 is a shared car of an electric vehicle, and includes a vehicle ID 112 which is an ID for identifying the vehicle 111 and a battery 113 which is an in-vehicle battery. The vehicle 111 is an example of the first vehicle. Chargers for charging and discharging the battery 113 of the vehicle 111 include a personal charger 21 owned by the user C, a company charger 22 owned by the corporation to which the user C belongs, and a general charger 23 for providing charging and discharging services to an unspecified number of people.

The chargers/dischargers are connected to a personal cloud 24, a company cloud 25, and a general cloud 26, which are unique computers, via a network, and mutually communicate information regarding charging/discharging and payment.

A vehicle management cloud 5 is a cloud in which a vehicle manufacturer manages the vehicle 111. A key management cloud 10 is a cloud that manages electronic keys for using the vehicle 111 among an unspecified number of users. The first computer is an example of the key management cloud 10, and is a computer that can access at least one database in which to manage vehicle information on a plurality of vehicles and a plurality of electronic keys corresponding to the plurality of vehicles.

At least one of the databases described above further manages insurance company information and address information, the insurance company information being related to a plurality of insurance companies with which a plurality of users or a plurality of business entities to which the plurality of users belongs has a contract, the address information indicating addresses, on a network, of a plurality of computers used by the plurality of insurance companies, in a case where the first electronic key is the first company key, first address information indicating an address, on the network, of the second computer used by the first insurance company is identified by checking the first company key with the at least one database, and in a case where the first electronic key is the first personal key, second address information indicating an address, on the network, of the third computer used by the second insurance company is identified by checking the first personal key with the at least one database.

In addition, a personal insurance cloud 27 and a company insurance cloud 28 are clouds used by insurance companies that have an insurance contract applied when the user C uses the vehicle 111 with the personal electronic key 91 and the company electronic key 81, respectively. The second computer is an example of the company insurance cloud 28, and is a computer used by the first insurance company with which the first business entity has a contract of a first automobile insurance. The second computer may be a business computer used by the first business entity. The third computer is an example of the personal insurance cloud 27, and is a computer used by the second insurance company with which the first user personally has a contract of a second automobile insurance.

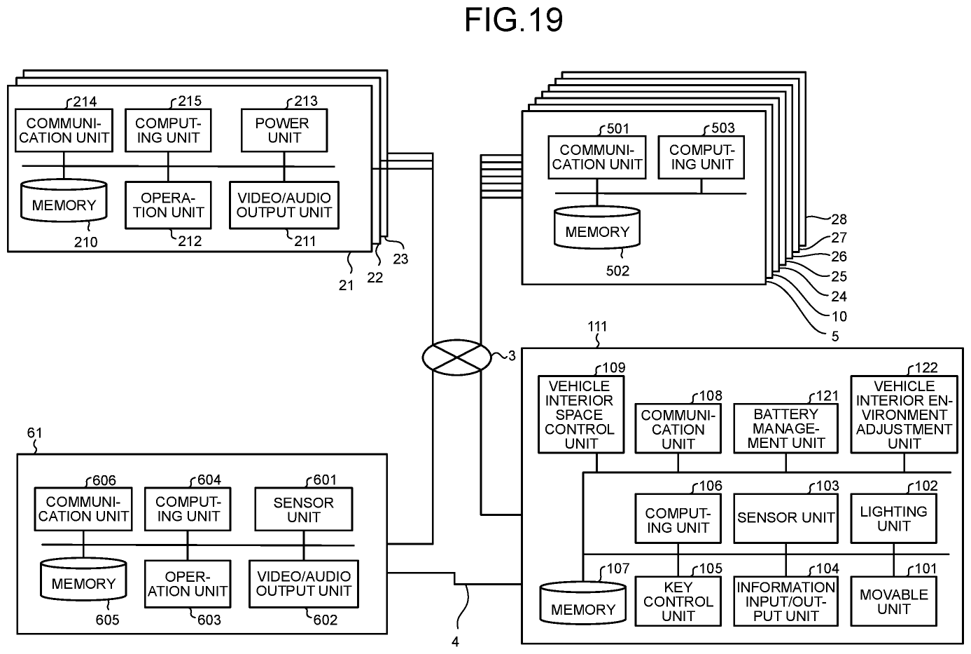

FIG. 19 is a block diagram illustrating an example of the configuration of the key management system 200. In addition to the configuration of FIG. 2, the vehicle 111 includes a battery management unit 121 that manages charging/discharging of the battery, and a vehicle interior environment adjustment unit 122 that adjusts lighting, air conditioning, and the like in the vehicle interior.

Each of the chargers (the personal charger 21, the company charger 22, and the general charger 23) includes a video/audio output unit 211 for presenting information to the user C, an operation unit 212 for the user C to perform an operation, a power unit 213 for managing charging/discharging for the vehicle 111, a communication unit 214 for communicating with an external computer, a computing unit 215 for performing overall control according to a program, and a memory 210 used for executing the program.

In FIG. 18, what is denoted as a cloud is a computer connected to a network or a computer system including a plurality of computers, and includes a communication unit 501, a memory 502, and a computing unit 503 as described above. Note that the communication units of the information terminal 61, the vehicle 111, the charger, and the cloud communicate with an external computer via the Internet, and further may directly perform communication via a near field communication technology.

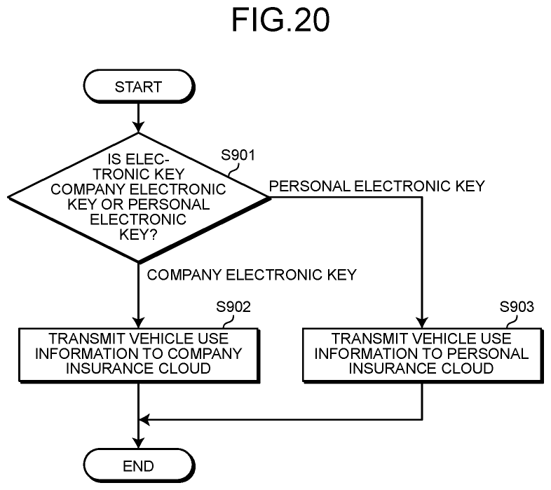

FIG. 20 is a flowchart illustrating an example of the configuration of the key management system 200. In a case where the first electronic key is the first company key, after determining that the first authentication information is valid, a first check request for requesting confirmation of an insurance for which the first business entity has a contract with the first insurance company is transmitted to the second computer via the network, in the second computer, based on the first check request, a first check result indicating that a contract detail of the first automobile insurance has been confirmed is received from the second computer via the network, and after receiving the first check result, the first permission signal is transmitted to the first vehicle.

In a case where the first electronic key is the first company key, the first authentication information further includes first address information indicating an address, on a network, of the second computer used by the first insurance company, and in a case where the first electronic key is the first personal key, the first authentication information further includes second address information indicating an address, on the network, of the third computer used by the second insurance company.

Specifically, first, the computing unit 503 of the key management cloud 10 determines whether the electronic key is the company electronic key 81 or the personal electronic key 91 (Step S901). When determining that the electronic key is the company electronic key 81, the computing unit 503 of the key management cloud 10 transmits vehicle use information acquired from the vehicle 111 to the company insurance cloud 28 (Step S902).

When determining that the electronic key is the personal electronic key 91, the computing unit 503 of the key management cloud 10 transmits the vehicle use information acquired from the vehicle 111 to the personal insurance cloud 27 (Step S903). In other words, when determining that the electronic key is the personal electronic key 91, the computing unit 503 of the key management cloud 10 does not transmit the vehicle use information acquired from the vehicle 111 to the company insurance cloud 28. In Step S902, the computing unit 503 of the key management cloud 10 may transmit the vehicle use information acquired from the vehicle 111 to the company cloud 25.

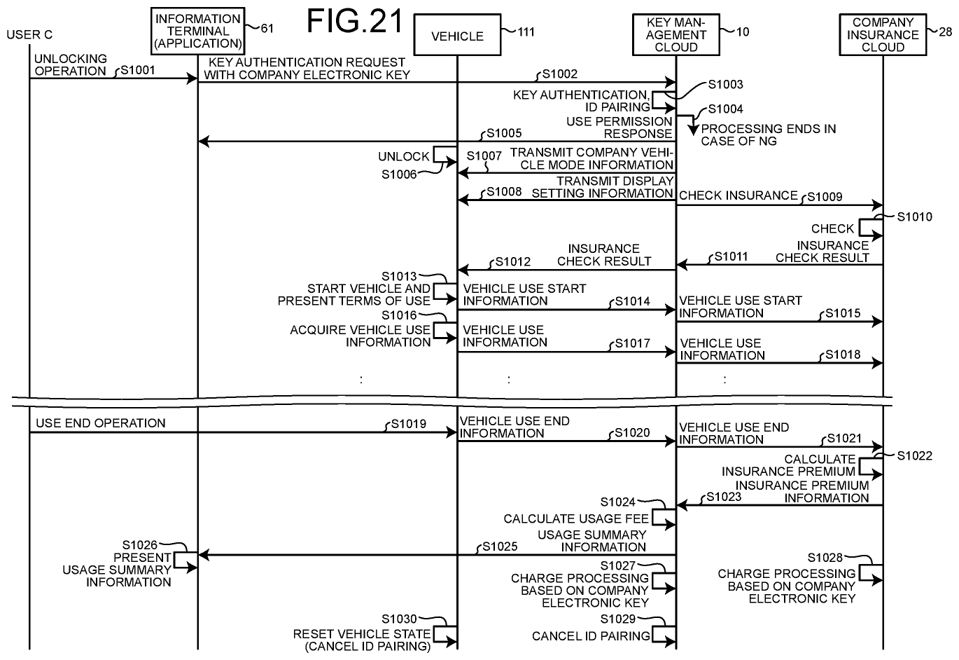

Next, FIG. 21 is a sequence diagram from when the user C uses the company electronic key 81 to start using the vehicle 111 that is a general-purpose shared car for company use to when the user C finishes using the vehicle 111.

Specifically, first, the user C launches the car sharing application installed on the information terminal 61, reads a vehicle ID of the vehicle 111 parked, and instructs an unlock operation (that is, start of use) of the vehicle 111 (Step S1001). At this time, the user C selects the company electronic key 81 according to the purpose of the current use from a plurality of electronic keys managed in the application. The vehicle ID may be read by the information terminal 61 from the vehicle 111 by near field communication such as NFC (registered trademark), or a two-dimensional code (for example, a QR code (registered trademark) or the like) given to the vehicle 111 may be read by a sensor (CMOS or the like) of the information terminal 61.

In response to the unlocking operation, the communication unit 606 of the information terminal 61 (or an application running on the information terminal, and the same applies hereafter) requests the key management cloud 10 to perform key authentication using the company electronic key 81 (Step S1002). The request includes a user ID that identifies the user C, a smart phone ID that identifies the information terminal 61 used by the user C, a vehicle ID that identifies the vehicle 111 to be used, an electronic key ID that identifies the company electronic key 81 selected by the user C, and connection information to the company insurance cloud 28 that manages insurance information applied at the time of using the vehicle with the company electronic key 81.

In response to the IDs and the connection information received in the key management cloud 10, pairing information of the IDs and the connection information is recorded in the memory 502, and the computing unit 503 determines availability (key authentication) (Step S1003), and if not available, then the processing ends (Step S1004). It is only required that the ID pairing information includes at least the vehicle ID and the electronic key ID. In a case where the use is permitted, a use permission (the first permission signal) response is sent to the information terminal 61 (Step S1005), and at the same time, a use permission including an unlock instruction for unlocking the doors of the vehicle 111 is transmitted to the vehicle 111, and the vehicle 111 that has received the use permission unlocks the doors under the control of the key control unit 105 (Step S1006).

In the key management cloud 10, the communication unit 501 transmits, to the vehicle 111, a first setting instruction for setting the control mode of the vehicle 111 to a company vehicle mode via the network (Step S1007). Further, in the key management cloud 10, the communication unit 501 transmits, to the vehicle 111 via the network, display setting information for displaying an indicator indicating a battery storage amount in the display in the vehicle interior of the vehicle 111 based on information on a battery charging history mounted on the vehicle 111 (Step S1008).

In the key management cloud 10, the communication unit 501 notifies the company insurance cloud 28 of vehicle type information (information relating to a vehicle shape such as a motorized bicycle, a regular motorcycle, a light automobile, a regular automobile, or a large automobile, and/or information for identifying a vehicle model) identified from the vehicle ID and the electronic key ID based on the designated connection information, and requests the company insurance cloud 28 to confirm whether the insurance is applicable (Step S1009). The company insurance cloud 28 acquires the vehicle type information of the vehicle 111 to be used and the corporation information using the vehicle 111 (identifiable with the electronic key ID), so that the company insurance cloud 28 can calculate appropriate insurance conditions.

In the company insurance cloud 28, the computing unit 503 confirms whether or not the insurance is applicable and the conditions based on these pieces of information (Step S1010), and the communication unit 501 sends the insurance check result to the key management cloud 10 (Step S1011). In the key management cloud 10, the communication unit 501 transmits the insurance check result to the vehicle 111 (Step S1012). In a case where the user C starts the vehicle 111, the information input/output unit 104 presents, to the user C, terms of use of the vehicle 111 and the insurance check result (terms of use of the insurance) based on the company electronic key 81 used for unlocking (Step S1013).

In a case where the first electronic key is the first company key, the first permission signal includes a first display instruction (terms of use of the vehicle 111 and the insurance check result (terms of use of the insurance)) for causing first insurance information indicating at least a part of the contract detail of the first automobile insurance to be displayed in a display provided in a vehicle interior of the first vehicle. This enables the user C to easily confirm the terms of use of the vehicle 111.

As the use of the vehicle 111 starts, the communication unit 108 transmits, to the key management cloud 10, the vehicle ID, the use start time, and the user information (the electronic key ID of the company electronic key 81, the user ID, and the smartphone ID) as vehicle use start information (Step S1014). In a case where the first electronic key is the first company key, at least a part of the first use information transmitted to the second computer may include the first vehicle ID and a first travel history in which the location information of the first vehicle is correlated with time information.

In response to the information received in the key management cloud 10, the communication unit 501 transmits the information to the company insurance cloud 28 for calculation of an insurance premium (Step S1015). In addition, while the user C uses the vehicle 111 with the company electronic key 81, the computing unit 106 acquires the use information of the vehicle 111 periodically and/or every time a predetermined event such as parking/stopping or charging/discharging occurs (Step S1016), and the communication unit 108 transmits the use information to the key management cloud 10 (Step S1017).

In the key management cloud 10, the communication unit 501 transmits, each time, all or a part of the information to the company insurance cloud 28 for calculation of an insurance premium (Step S1018). Note that the vehicle use information may be directly transmitted from the vehicle 111 to the company insurance cloud 28 without going through the key management cloud 10. In that case, transmission address information to the company insurance cloud 28 may be added to the insurance check result at the preceding stage.

In a case where the user C performs an operation to end the use of the vehicle on the vehicle 111 (for example, selecting the end of use from a menu displayed on the information input/output unit 104 of the vehicle 111 or the video/audio output unit 602 of the information terminal 61) (Step S1019), the vehicle 111 receives the operation and the communication unit 108 transmits vehicle use end information indicating that the use of the vehicle has ended to the key management cloud 10 (Step S1020). In response to the information received in the key management cloud 10, the communication unit 501 transmits the vehicle use end information to the company insurance cloud 28 (Step S1021).

In the company insurance cloud 28, the computing unit 503 calculates an insurance premium based on the vehicle use start information and the vehicle use end information (including the vehicle use information if necessary) (Step S1022), and the communication unit 501 transmits the insurance premium as insurance premium information to the key management cloud 10 (alternatively, may be the vehicle 111 or the information terminal 61) (Step S1023).

In the key management cloud 10, the computing unit 503 calculates a vehicle usage fee (usage fee) based on the vehicle use start information and the vehicle use end information (including the vehicle use information if necessary) (Step S1024), the computing unit 503 generates usage summary information by adding the received insurance premium, and the communication unit 501 transmits the usage summary information to the information terminal 61 (Step S1025). The information terminal 61 receives the usage summary information, and the video/audio output unit 602 presents the usage summary information (Step S1026). The usage summary information may be transmitted to the vehicle 111, and, in such a case, the information input/output unit 104 of the vehicle 111 presents the usage summary information.

Further, in the key management cloud 10, the computing unit 503 charges the usage fee for the vehicle 111 based on billing information (account information or credit card information of the corporation) correlated with the company electronic key 81 used for unlocking operation (Step S1027). Similarly, in the company insurance cloud 28, the computing unit 503 charges an insurance premium based on the billing information correlated with the company electronic key 81 (Step S1028). The billing information may be managed in correlation with the company electronic key 81 in advance by each of the key management cloud 10 and the company insurance cloud 28, or, alternatively may be acquired from the key management cloud 10 or the information terminal 61 via the network when necessary. Alternatively, the billing amounts may be collectively billed in the key management cloud 10.

Finally, in the key management cloud 10 (also in the vehicle 111 in a case of transmitting the ID pairing information also to the vehicle 111 in the use permission response), the computing unit 503 discards the ID pairing information (Step S1029). Thereafter, the computing unit 106 of the vehicle 111 resets the vehicle state of the vehicle 111 (Step S1030). Note that, the vehicle 111 transmits the vehicle use start information, the vehicle use information, and the vehicle use end information at a time when each of the pieces of information is generated; however, the present disclosure is not limited thereto. The pieces of information may be recorded in the memory 107 of the vehicle 111, and may be collectively transmitted to the key management cloud 10 and/or the company insurance cloud 28 in response to the user C performing a use end operation.

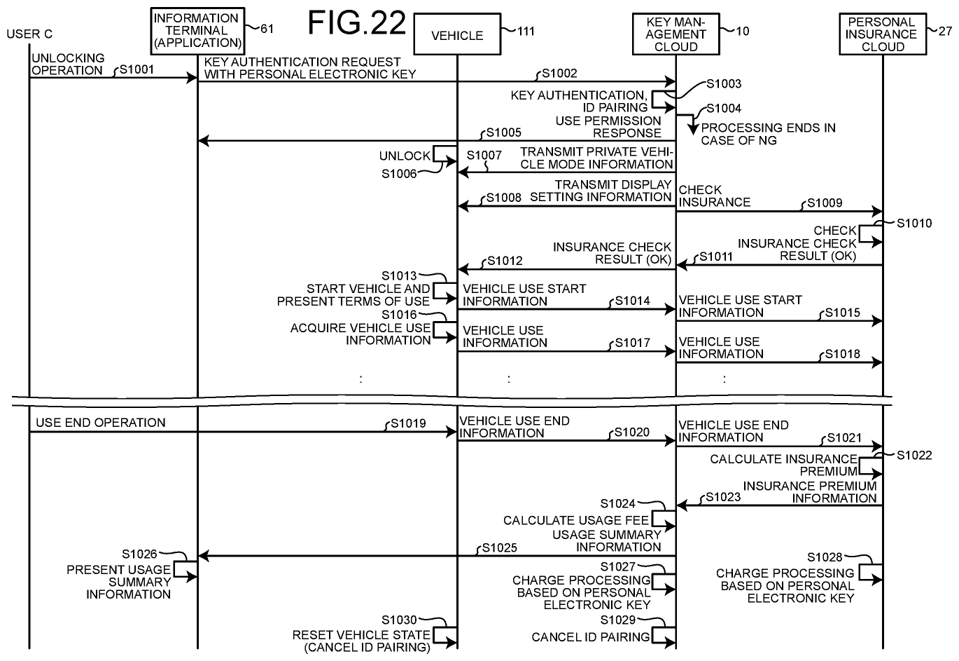

FIG. 22 is a sequence diagram from when the user C uses the personal electronic key 91 to start using the vehicle 111 that is a general-purpose shared car for private use to when the user C finishes using the vehicle 111. Further, FIG. 22 illustrates a case where the user C has an insurance policy, and use of the insurance is permitted in the personal insurance cloud 27. Since the processing itself has the same flow as that of FIG. 21, the company electronic key 81 may be replaced with the personal electronic key 91, and the company insurance cloud 28 may be replaced with the personal insurance cloud 27.

In Step S1002 to Step S1005 in FIG. 22, in a case where the first electronic key is the first personal key, after determining that the first authentication information is valid, a second check request for requesting confirmation of an insurance for which the first user has a contract with the second insurance company is transmitted to the third computer via the network, in the third computer, based on the second check request, a second check result indicating that a contract detail of the second automobile insurance has been confirmed is received from the third computer via the network, and after receiving the second check result, the first permission signal is transmitted to the first vehicle.

In Step S1007 in FIG. 22, in the key management cloud 10, the communication unit 501 transmits, to the vehicle 111, a second setting instruction for setting the control mode of the vehicle 111 to a private vehicle mode for personal use via the network (Step S1007).

In Step S1013 in FIG. 22, in a case where the user C starts the vehicle 111, the information input/output unit 104 presents, to the user C, terms of use of the vehicle 111 and the insurance check result (terms of use of the insurance) based on the personal electronic key 91 used for unlocking (Step S1013). In a case where the first electronic key is the first personal key, the first permission signal includes a second display instruction for causing second insurance information (terms of use of the vehicle 111 and the insurance check result (terms of use of the insurance)) indicating at least a part of the contract detail of the second automobile insurance to be displayed in the display provided in a vehicle interior of the first vehicle.

Further, in the personal insurance cloud 27, appropriate insurance conditions can be calculated by acquiring the vehicle type information on the vehicle 111 to be used and the personal information to be used (one or more of the electronic key ID, the user ID, and the smart phone ID) that are received from the key management cloud 10.

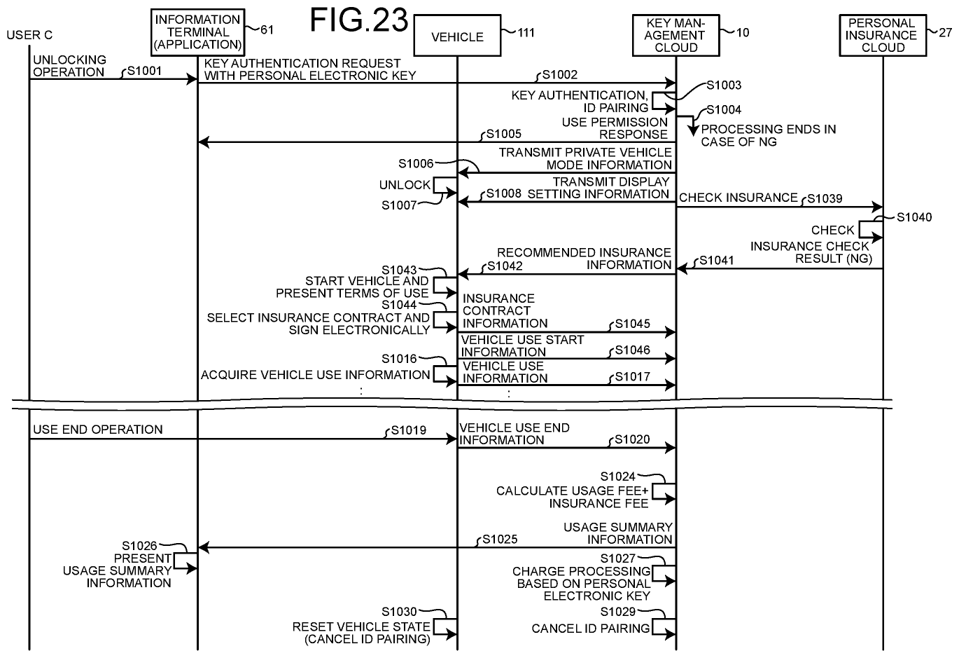

FIG. 23 is the same scenario as FIG. 22, and is a sequence diagram for a case where the validity of an insurance contract cannot be confirmed in the personal insurance cloud 27.

In this case, in the key management cloud 10, the communication unit 501 notifies the personal insurance cloud 27 of the vehicle type information identified from the vehicle ID and the electronic key ID of the personal electronic key 91 based on the designated connection information, and requests the personal insurance cloud 27 to confirm whether the insurance is applicable (Step S1039). In the personal insurance cloud 27, the computing unit 503 acquires the vehicle type information on the vehicle 111 to be used and the personal information to be used (one or more of the electronic key ID, the user ID, and the smart phone ID), the personal insurance cloud 27 confirms whether or not the insurance is applicable and the conditions thereof based on the pieces of information (Step S1040), and the communication unit 501 sends an insurance check result (NG) indicating that the validity of the insurance contract cannot be confirmed to the key management cloud 10 (Step S1041). In a case where the personal insurance cloud 27 cannot be identified, the processing of the key management cloud 10 may proceed to Step S1042 as an insurance check result (NG) without confirmation request in Step S1039.

In response to this, in the key management cloud 10, the communication unit 501 transmits recommended insurance information recommended to the user C to the vehicle 111 (or the information terminal 61) (Step S1042). The recommended insurance information may be based on a contract entered into between the shared car operating company and an insurance company in advance. In response to the user C starting the vehicle 111, the information input/output unit 104 of the vehicle 111 presents the acquired recommended insurance information to the user C (Step S1043).

The user C selects one insurance contract from among the recommended insurance information with the information input/output unit 104, and signs electronically using information (biometric information, a driver's license, a password, a secret key, the information terminal 61 of the user C, and the like) for authenticating the user C (Step S1044). In the vehicle 111, the communication unit 108 transmits the electronically signed insurance policy information to the key management cloud 10 (Step S1045), and the key management cloud 10 stores the insurance policy information in the memory 502.

In a case where the first electronic key is the first personal key, and further in a case where an automobile insurance contracted personally by the first user cannot be identified, the key management cloud 10 transmits, to the first vehicle via the network, a display instruction signal for displaying recommended insurance information indicating an automobile insurance to be recommended to the first user in a display provided in a vehicle interior of the first vehicle, receives a third check result (electronic signature) indicating that the first user has taken the recommended automobile insurance from the first vehicle via the network, and after receiving the third check result, permits the first user to use the first vehicle.

Hereinafter, although the key management cloud 10 calculates the insurance premium, the present disclosure is not limited thereto, and similarly to FIG. 22, the key management cloud 10 (or the vehicle 111) may transmit, via the network, the vehicle use start information, the vehicle use information, and the vehicle use end information to a cloud of an insurance company contracted with the shared car operating company (Step S1046) so that the cloud of the insurance company calculates the insurance premium.

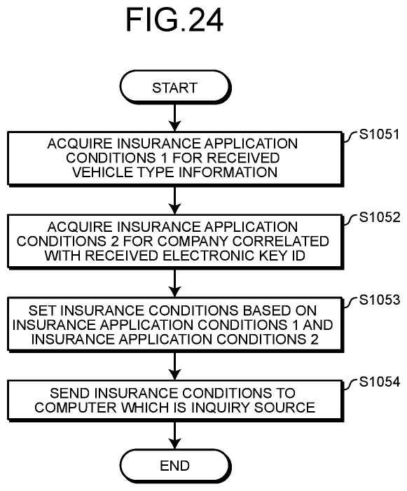

FIG. 24 is a flowchart for explaining a part of the processing in FIG. 21, namely, calculation of an insurance premium in the company insurance cloud 28. As illustrated herein, in the company insurance cloud 28, the computing unit 503 acquires, from the memory 502 of the company insurance cloud 28, insurance application conditions 1 for the vehicle type information acquired from the key management cloud 10 (or, may be the vehicle 111 or the information terminal 61) (Step S1051). The memory records, thereon, a table in which insurance application conditions to be applied according to the vehicle type information are predefined, and the company insurance cloud 28 reads the insurance application conditions for the corresponding vehicle type information based on the table to acquire the read insurance application conditions as the insurance application conditions 1.

In the company insurance cloud 28, the computing unit 503 acquires, from the memory 502 of the company insurance cloud 28, insurance application conditions 2 for a company correlated with the electronic key ID acquired from the key management cloud 10 (or, may be the vehicle 111 or the information terminal 61) (Step S1052). The memory records, thereon, a table in which insurance application conditions to be applied according to a corporation or an organization are predefined, and the company insurance cloud 28 reads the insurance application conditions for the company correlated with the electronic key ID based on the table to acquire the read insurance application conditions as the insurance application conditions 2.

In the company insurance cloud 28, the computing unit 503 sets insurance conditions to be applied this time based on the insurance application conditions 1 and the insurance application conditions 2 (Step S1053). The memory records, thereon, a table predefined according to a combination of the insurance application conditions 1 and the insurance application conditions 2, and the company insurance cloud 28 determines the insurance conditions based on the table. Then, in the company insurance cloud 28, the communication unit 501 transmits (Step S1054) the insurance conditions to the key management cloud 10 (or, may be the vehicle 111 or the information terminal 61) that has inquired about the insurance conditions, and ends the processing.

Of course, in the company insurance cloud 28, the insurance conditions to be applied may be acquired using one table in which insurance conditions for each vehicle type information are described for the company correlated with the electronic key ID, and the communication unit 501 may transmit the insurance conditions to the key management cloud 10. Note that the flowchart of FIG. 24 is the same in the processing for determining insurance conditions in the personal insurance cloud 27 of FIGS. 22 and 23 except for the insurance application conditions 2. The insurance application conditions 2 are insurance application conditions set for an individual user correlated with the electronic key ID received by the personal insurance cloud 27.

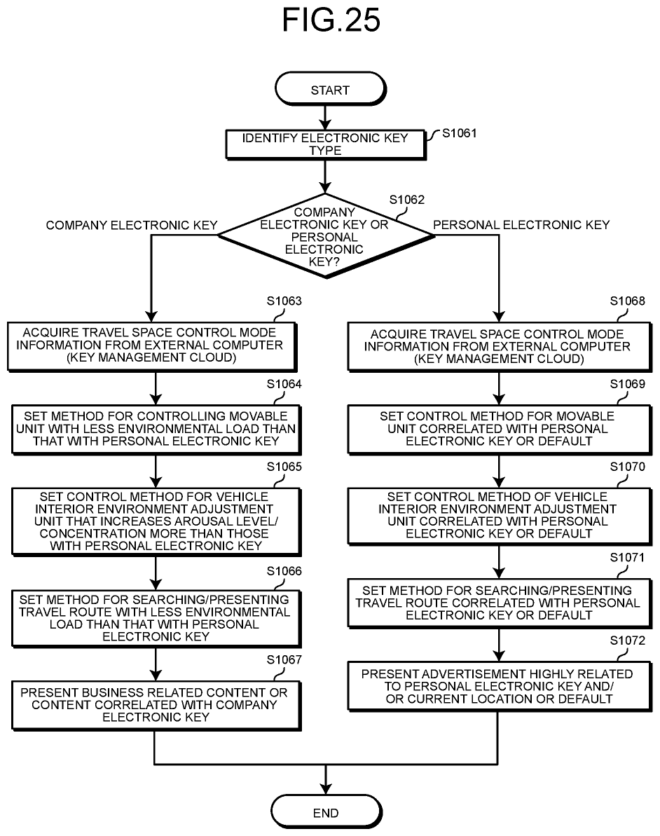

FIG. 25 is a flowchart illustrating that control is automatically changed according to the type of an electronic key used for the vehicle 111.

The computing unit 106 of the vehicle 111 identifies a type (company electronic key 81 or personal electronic key 91) of the electronic key to be used based on the received electronic key ID (Step S1061). In the vehicle 111, if the computing unit 106 determines that the type of the electronic key is the company electronic key 81 (Step S1062: company electronic key), then the computing unit 106 acquires travel space control mode information set to the company electronic key 81 from an external computer (at least any one of the key management cloud 10, the company cloud 25, and the information terminal 61) (Step S1063).

The computing unit 106 of the vehicle 111 sets a method for controlling the movable unit 101 with less environmental load based on the travel space control mode information (Step S1064). Further, the computing unit 106 instructs the movable unit 101 to apply a travel space control mode set in the company electronic key 81, which has a smaller environmental load than a travel space control mode set in the personal electronic key 91. For example, even if a sensor (accelerator pedal position sensor) detects the same accelerator pedal opening degree, the movable part (and the battery management unit 121) is controlled to operate so as to generate less output in the case of the company electronic key 81 than in the case of the personal electronic key 91.

In addition, a maximum amount of a temporal change of the accelerator pedal opening degree may be provided such that an output change is temporally gradual with respect to a sudden accelerator pedal operation. In this way, smooth acceleration/deceleration is achieved, the power consumption per distance travelled is made efficient, and traveling can be implemented more economical and environmentally friendly.

The computing unit 106 of the vehicle 111 sets, based on the travel space control mode information, a method for controlling the vehicle interior environment adjustment unit 122 so as to achieve a vehicle interior environment in which the arousal level of the passenger can be increased or the concentration of the passenger can be easily increased (Step S1065). For example, an air purifying function of the vehicle interior environment adjustment unit 122 is used to provide clear air quality by setting the concentration of dust such as allergic substances, pollen, and PM 2.5 in the vehicle interior to be lower than that in the case of the personal electronic key 91.

It is also possible to provide a similar effect by setting the concentration of ions having a function to reduce harmful substances in the air such as bacteria, viruses, and odor, e.g., such as nanoe (registered trademark) to be higher than that of the case of the personal electronic key 91. Further, a color temperature of the lighting function for the interior of the vehicle in the vehicle interior environment adjustment unit 122 is set to be higher than that of the case of the personal electronic key 91, which makes it possible to provide a vehicle interior environment in which the concentration for active and intelligent work and the like can be easily increased.

The computing unit 106 of the vehicle 111 controls the information input/output unit 104 to search for and present a travel route with less environmental load based on the travel space control mode information (Step S1066). For example, in a case where a route selection to a destination is made by the information input/output unit, a route with a better electric cost (fuel consumption) than that of the case of the personal electronic key 91 is displayed/recommended from among a plurality of route candidates, or settings for displaying/recommending a route with smaller carbon emissions is made based on a result of trial calculation of the carbon emissions involved in traveling. This makes it possible to reduce the carbon emissions of the user C and the carbon emissions of Scope 3 of the company correlated with the company electronic key 81.

The computing unit 106 of the vehicle 111 controls the information input/output unit 104 to present business related information or a content highly correlated with the company electronic key 81 based on the travel space control mode information (Step S1067).

For example, using the company electronic key 81 means that the user is on duty; therefore, related business news, content for employees of the company correlated with the company electronic key 81, or the current location information of other employees are presented. This enables acquiring information regarding business at the time of traveling for business, so that increased efficiency can be expected.

In a case where the company electronic key 81 is identified based on the type of the electronic key, the computing unit 106 of the vehicle 111 performs the above setting and processing, and ends the flow. On the other hand, if the personal electronic key 91 is identified (Step S1062: personal electronic key), then in the computing unit 106 of the vehicle 111, a default preset for the vehicle 111 or a control method based on the travel space control mode information set in correlation with the personal electronic key 91 is set for various devices (Step S1068).

The computing unit 106 of the vehicle 111 may ease the acceleration/deceleration limitation on the movable unit 101 of the vehicle 111 as compared with the case of the company electronic key 81, or may perform output control according to the preference of the user C (Step S1069). For example, in a case where the user C sets a sport mode in his/her personal electronic key 91, settings are so applied that the movable unit 101 is controlled to be accelerated more easily than that of default settings in the vehicle 111.

The computing unit 106 of the vehicle 111 may be set by the air temperature adjustment function of the vehicle interior environment adjustment unit 122 such that the air temperature in the vehicle interior may be designated up to a temperature having a larger difference from the outside air temperature, as compared with the case of the company electronic key 81 (Step S1070). In addition, the color temperature of the lighting function may be set (or settable) to be lower to facilitate relaxation in the vehicle interior.

In the route selection to the destination in the information input/output unit 104, the computing unit 106 of the vehicle 111 may control the information input/output unit 104 so as to display/recommend, from among a plurality of route candidates, a route with a shorter travel time as compared with the case of the company electronic key 81, a route with a bad electricity cost, or a route expected to have large carbon emissions (Step S1071).

A first travel distance of a first route from a first departure place to a first destination in the company vehicle mode is longer than a second travel distance of a second route from the first departure place to the first destination in the private vehicle mode, or, alternatively, a first travel time taken in a case of traveling from the first departure place to the first destination in the company vehicle mode is longer than a second travel time taken in a case of traveling from the first departure place to the first destination in the private vehicle mode.

Alternatively, the expected electricity consumption (or the fuel consumption of gasoline or hydrogen) involved in traveling of the vehicle which takes the first route may be smaller than the expected electricity consumption in the case of traveling on the second route. Alternatively, the expected greenhouse gas emissions involved in traveling of the vehicle which takes the first route may be smaller than the expected greenhouse gas emissions in the case of traveling on the second route.

In addition, the computing unit 106 of the vehicle 111 makes such settings that the information input/output unit 104 presents not only business related information but also information highly correlated with interest information correlated with the personal electronic key 91, and advertisement information near the current location of the vehicle 111 (Step S1072).

That is, in the company vehicle mode, first advertisement information for the first user is displayed on the display provided in the vehicle interior of the first vehicle, and in the private vehicle mode, second advertisement information for the first user is displayed on the display, and at least one of the display frequency, the display position, and the display content of the first advertisement information is different from that of the second advertisement information.

In addition, advertisement information regarding food, drink, and entertainment that are not included in the first advertisement information may be included in the second advertisement information. Alternatively, in the second advertisement information, the display frequency of the advertisement information regarding food, drink, and entertainment and the type of the display content thereof may be enlarged as compared with the first advertisement information.

As described above, it is possible that methods for controlling the movable unit 101, the vehicle interior environment adjustment unit 122, and the information input/output unit 104 of the vehicle 111 are switched based on the type of the electronic key used for unlocking by the vehicle user. The travel space control mode may be preset by the user C with the information terminal 61, and may be transmitted from the information terminal 61 to the vehicle 111 at the start of using the vehicle.

Although the processing herein is performed by the vehicle 111, the processing may be performed by an external computer (key management cloud 10, vehicle management cloud 5, and the like) that communicates with the vehicle 111 via the network. In such a case, the computing unit 503 of the external computer acquires the travel space control mode information set for the corresponding company electronic key 81 or personal electronic key 91, and transmits a request for setting the travel space control mode information to the vehicle 111 via the communication unit 501.

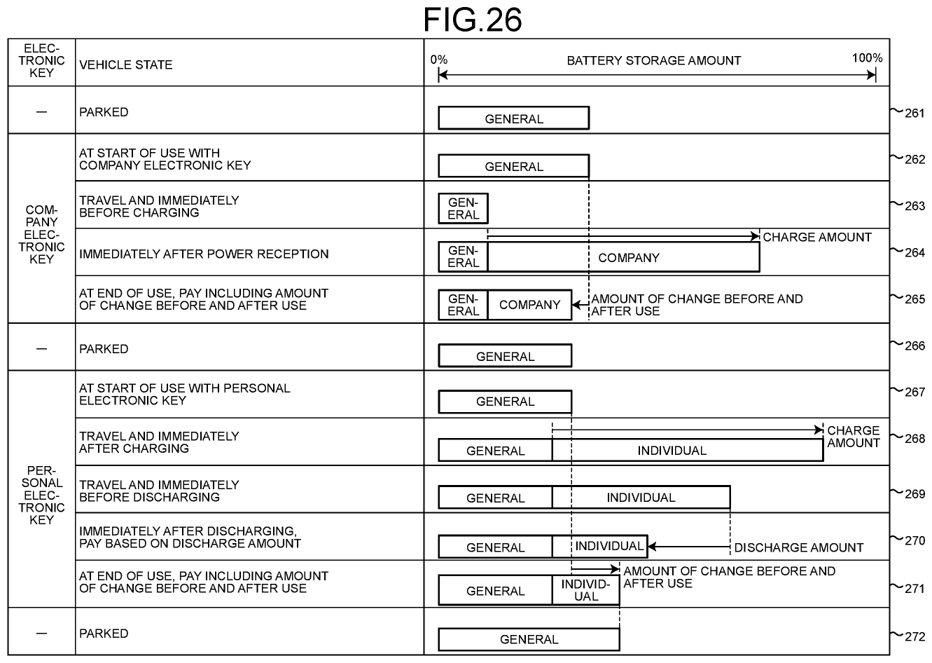

FIG. 26 is a diagram illustrating a vehicle state after the user C uses a shared car for business purposes using the company electronic key 81 and a battery storage amount at the time, and a vehicle state after the user C uses a shared car for private purposes using the personal electronic key 91 and a battery storage amount at the time.

First, the top row 261 indicates a state in which the vehicle 111 is parked in a parking lot before the start of use. The battery storage amount is measured by the battery management unit 121, and is sequentially managed by the vehicle 111 and the key management cloud 10. All the electricity stored in the battery before using the vehicle is classified and displayed as “general” on the assumption that all the electricity is charged and/or paid by a service operating company for shared car.

The classification herein is information, for the battery storage amount corresponding to the classification, for identifying at least one or more of the owner of the key used at the time of charging, the individual or corporation that has paid for the charge, the individual or corporation that performed the charging operation, and the individual or corporation that owns or operates a charger used for the charging.

The next row 262 indicates a state at a time when the user C starts using the vehicle 111 with the company electronic key 81. The battery storage amount herein is the same as the one described above. The “company electronic key” in the column of the electronic key indicates that the corresponding rows show the use with the company electronic key 81. The next row 263 indicates that the vehicle 111 used by the user C has run and the charge amount has decreased. This state is a state immediately before charging.

The next row 264 indicates a state immediately after the vehicle 111 is charged, and the battery storage amount is increased. Here, the charge amount is classified and illustrated as “company”, which means that the company electronic key 81 is used for charging. The charge amount illustrated in the drawing is the amount of electricity charged while the company electronic key 81 is used.

The next row 265 indicates a state at a time when the user C finishes using the vehicle 111. The battery storage amount is reduced to a point slightly smaller than that at the start of use by traveling. The user C pays the usage fee to the shared car operating company including the change amount (the amount of change before and after use<0) of the battery storage amount between the start of use and the end of use. In a case where the amount of change before and after use has a negative value, the usage fee is high.

At a start of using the first vehicle with the first company key, first battery information indicating a first storage amount stored in a battery mounted on the first vehicle is acquired from the first vehicle via the network, at an end of using the first vehicle with the first company key, second battery information indicating a second storage amount stored in the battery is acquired from the first vehicle via the network, and payment processing is executed with an amount of money reflecting an amount of change from the first storage amount to the second storage amount for the business computer used by the first business entity, or, for a financial computer used by a financial institution managing a payment method of the first business entity.

The next row 266 indicates a state in which the vehicle 111 is again parked in a parking lot before the start of use, as with the case of the first time. At this time, the battery storage amount is no longer classified into “general” and “company” again, and is expressed as “general” for the next user, assuming that all the electricity is charged by the shared car operating company.

The next row 267 indicates that the same or another user C has started using the vehicle 111 with the personal electronic key 91. At the start of using the vehicle 111, the battery storage amount indicated as “general” in the immediately preceding row is presented to the user C as it is. The next row 268 indicates a state immediately after the vehicle 111 used by the user C runs and the storage amount indicated by “general” is decreased and the charge amount indicated by “individual” is charged using the personal electronic key 91.

The next row 269 indicates a state immediately before the vehicle 111 used by the user C runs and the storage amount classified as “individual” is reduced and discharged. The next row 270 indicates a state immediately after the battery of the vehicle 111 is discharged. The discharge amount is the amount illustrated in the drawing, and the storage amount classified as “individual” is further reduced by the discharge.

The next row 271 indicates a state at a time when the user C finishes using the vehicle 111. As with the case described above, the user C settles the bill and pays the usage fee to the shared car operating company including the change amount (the amount of change before and after use>0) of the battery storage amount between the start of use and the end of use. In a case where the amount of change before and after use has a positive value, the usage fee is low.

The payment processing is executed with an amount of money reflected in at least one of the first storage amount and the second storage amount for the business computer used by the first business entity, or, for a financial computer used by a financial institution managing a payment method of the first business entity, and in the payment processing, in a case where the first storage amount is equal to or less than a first reference amount, or, in a case where the second storage amount is equal to or more than a second reference amount, the amount of money is subtracted from a predetermined amount of money. The next row 272 indicates a state in which the vehicle 111 is on standby for use start again (parked), and the battery storage amount is integrated into the category of “general”.

Herein, the classification of the battery storage amount is represented as “general”, “company”, and “individual”, and each of the “general”, “company”, and “individual” indicates the owner of the battery storage amount. “General” means that the shared car operating company owns the battery storage amount, “company” means that the corporation indicated by the used company electronic key 81 owns the battery storage amount, and “individual” means that the individual indicated by the used personal electronic key 91 owns the battery storage amount.

As a result, it can be considered that, at the time of returning the shared car, the shared car operating company, a corporation or the shared car operating company, and an individual make a sales transaction of electricity based on the amount of change before and after use. This makes it possible for the user to easily understand the display of the remaining battery storage amount and the payment processing.

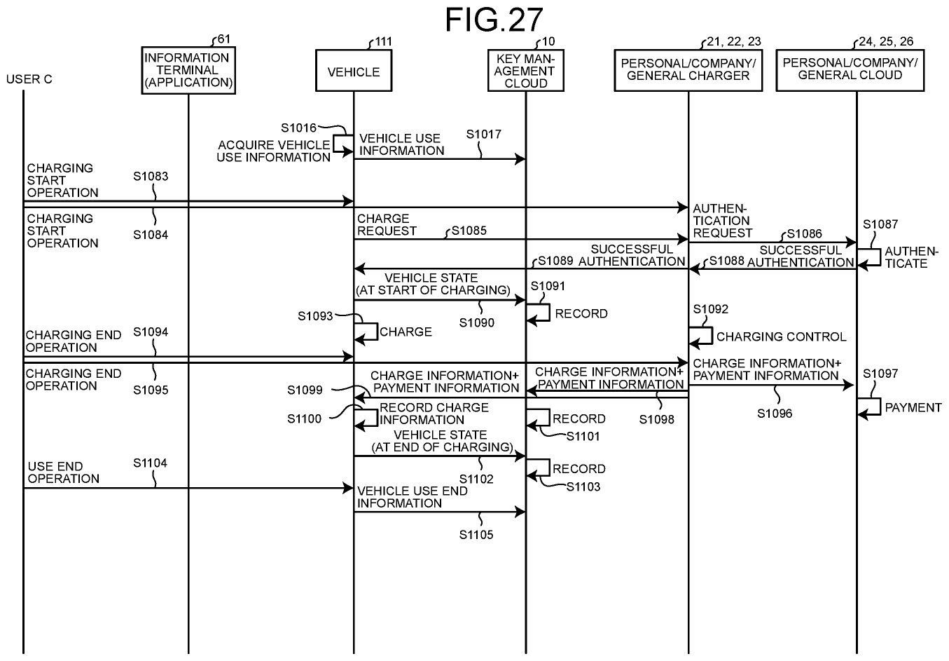

FIG. 27 is a sequence diagram for a case where the vehicle 111 is used with the company electronic key 81. In the diagram, authentication, control, and payment of charging are performed by communication between the vehicle 111 and a charger. Processing before the vehicle use information is transmitted from the vehicle 111 to the key management cloud 10 and the company insurance cloud 28 (not illustrated) and processing after the vehicle 111 transmits the vehicle use end information to the key management cloud 10 in response to the use end operation are the same as those in FIG. 21, and thus are omitted.

While the user C uses the vehicle 111 with the company electronic key 81, the vehicle 111 transmits, to the key management cloud 10, the use information of the vehicle 111 periodically and/or every time a predetermined event such as parking/stopping or charging/discharging occurs, and each time, the key management cloud 10 transmits all or a part of the information to the company insurance cloud 28 for calculating the insurance premium.

As the charging start operation, the user C connects the vehicle 111 and the charger with a wired power line or adjusts the positional relationship between the vehicle 111 and the charger so that power can be supplied wirelessly (Step S1083, Step S1084). In response to the operation, a charge request is transmitted from the vehicle 111 to the charger (Step S1085). The charge request may include information on the vehicle ID, the user ID, and the company electronic key 81 (the electronic key ID and payment method information such as a bank account corresponding to the company electronic key 81 or a credit card). Upon receiving the request, the communication unit 214 of the charger requests a cloud corresponding to the charger to authenticate the payment method based on the information of the charge request (Steps S1086 and S1087).

The chargers herein is any one of the personal charger 21 owned by the user C, the company charger 22 owned by the corporation to which the user C belongs, and the general charger 23 for providing charging and discharging services to an unspecified number of people. The corresponding cloud is the personal cloud 24 corresponding to the personal charger 21, the company cloud 25 corresponding to the company charger 22, or the general cloud 26 corresponding to the general charger 23.

In a case where the authentication request is not permitted by the computing unit 503 of the cloud, the charger is caused to display a message prompting the user to set the payment method until an available payment method can be confirmed (not illustrated). In a case where the authentication request is permitted by the computing unit 503 of the cloud, the communication unit 501 of the cloud transmits a response of successful authentication to the charger (Step S1088). Then, the communication unit 214 of the charger sends a response of successful authentication also to the vehicle 111 (Step S1089).

As a result, the communication unit 108 of the vehicle 111 transmits the vehicle state (the vehicle ID, the battery storage amount, the electronic key ID) at the start of charging to the key management cloud 10 (Step S1090), and the key management cloud 10 records the vehicle state in the memory 502 (Step S1091). Then, the vehicle 111 charges the battery while performing charge control with the charger (Steps S1092 and S1093).

As the charging end operation, the user C disconnects the connection between the vehicle 111 and the charger with the wired power line, or instructs to finish charging using the video/audio output unit 211 and the operation unit 212 of the charger (Step S1094, Step S1095).

The communication unit 214 of the charger transmits, to the corresponding cloud, charge information including a charging time, a charge amount, a charger ID (information for identifying the charger), the vehicle ID, and the company electronic key 81 (electronic key ID), and payment information including a charge fee and payment method information (Step S1096). The computing unit 503 of the corresponding cloud that has received the pieces of information makes a payment using a payment method correlated with the company electronic key 81 (Step S1097).

The communication unit 214 of the charger transmits the charge information and the payment information to the vehicle 111 and the key management cloud 10 (Step S1098, Step S1099), the charge information is recorded in the memory 107 of the vehicle 111 (Step S1100), and the charge information and the payment information are recorded in the memory 502 of the key management cloud 10 (Step S1101).

After a charging operation by a first charger is performed on a battery mounted on the first vehicle in a use period of the first vehicle with the first company key, a first payment report (payment information) is received which indicates that payment processing has been performed between the first charger and the business computer used by the first business entity or a financial computer (cloud) used by a financial institution managing a payment method of the first business entity from the first charger, the business computer, or the financial computer via the network, and the first payment report is correlated with the first company key and the resultant is recorded in a memory of the first computer.

In response to the occurrence of the event of the end of charging, the vehicle state is transmitted from the communication unit 108 of the vehicle 111 to the key management cloud 10 (Step S1102), and the vehicle state is recorded in the memory 502 in the key management cloud 10 (Step S1103).

When the user C performs the use end operation (Step S1104), the vehicle use end information is transmitted from the communication unit 108 of the vehicle 111 to the key management cloud 10 (Step S1105). The processing onward is the same as that illustrated in FIG. 21, and thus the description thereof is omitted. Details of the calculation of the usage fee associated with the amount of change before and after use of the battery storage amount will be described later.

As described above, the usage fee for the shared car used with the company electronic key 81 is paid based on the payment method information correlated with the company electronic key 81. Therefore, the user C does not need to set the payment method each time at the payment, and the shared car operating company can also eliminate a state and trouble such as a failure to make a payment at the end of use.

Further, as described with reference to FIG. 21, at the same time as the end of use, the pairing information of the ID indicating the personal information and the company information of the user C is automatically deleted from the key management cloud 10 (and the vehicle 111). This eliminates concerns about handling of personal information protection in a shared car used by an unspecified number of people.

Although charging in a charger is described above, the present disclosure is similarly applicable to the case of discharging. In the case of discharge, the charger or the corresponding cloud preferably calculates a discharge fee based on the discharge amount discharged from the vehicle 111 to the charger, and the discharge fee is preferably paid to the payment method correlated with the company electronic key 81.

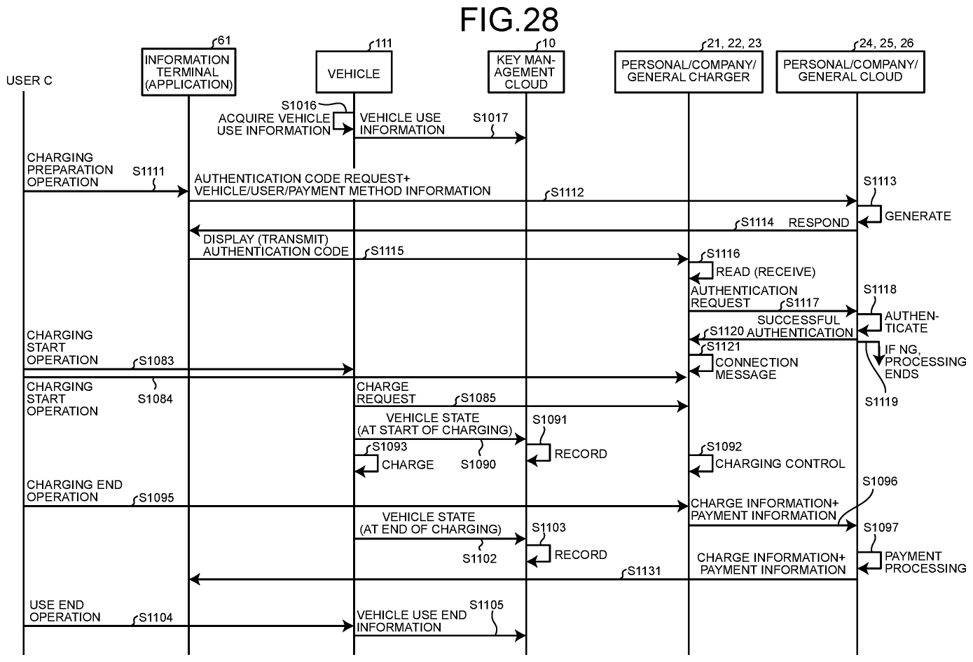

Although the above description takes an example of the use with the company electronic key 81, the same applies to the case of the use with the personal electronic key 91. In the case of the personal electronic key 91, the charge fee (discharge fee) at the charger and the usage fee for the shared car are preferably paid to the payment method correlated with the personal electronic key 91. The advantages and applications described herein are similarly applicable to the case of FIG. 28.

FIG. 28 is a sequence diagram for a case where the vehicle 111 is used with the company electronic key 81. In the diagram, authentication, control, and payment of charging are performed by the information terminal 61 and the charger working in coordination. Processing before the vehicle use information is transmitted from the vehicle 111 to the key management cloud 10 and the company insurance cloud 28 (not illustrated) and processing after the vehicle 111 transmits the vehicle use end information to the key management cloud 10 in response to the use end operation are omitted as with the case of FIG. 27. Hereinafter, only differences from FIG. 27 will be described.

As a charging preparation operation, the user C operates the information terminal 61 (Step S1111), launches an application provided by the shared car operating company or the operating company of the general charger 23, and requests an authentication code from a cloud corresponding to the charger to be used (Step S1112). The cloud corresponding to the charger to be used receives the request, generates the authentication code with the computing unit 503 (Step S1113), and transmits the generated authentication code to the information terminal 61 (Step S1114).

The authentication code request may include necessary information (the vehicle ID, the user ID, the smart phone ID, the electronic key ID of the company electronic key 81, and the payment method information correlated with the company electronic key 81) in advance in order to smoothly generate the charge information and the payment information and to reduce the labor of the user C.

The information terminal 61 receives the authentication code to display the authentication code on the video/audio output unit 602. The user C uses the information terminal 61 to present (transmit) the displayed authentication code so that an optical sensor (not illustrated) of the charger can read the displayed authentication code (Step S1115). The charger reads the authentication code (Step S1116), and the communication unit 214 makes an authentication request to the corresponding cloud (Step S1117).

The computing unit 503 of the cloud, which has received the request, authenticates the validity of the authentication code (Step S1118), and if the authentication is not successful, the processing ends (Step S1119), on the other hand, if the authentication is successful, the communication unit 501 transmits a response of successful authentication to the charger (Step S1120). Upon receiving the response of successful authentication, the charger presents a message to the user C to prompt him/her to start charging via the video/audio output unit 211 (Step S1121).

As the charging start operation, the user C connects the vehicle 111 and the charger with a wired power line or adjusts the positional relationship between the vehicle 111 and the charger so that power can be supplied wirelessly (Step S1083, Step S1084). In response to the operation, the communication unit 108 of the vehicle 111 transmits a charge request to the charger (Step S1085). The charge request may include information on the vehicle ID, the user ID, and the company electronic key 81 (electronic key ID).

As the charging end operation, the user C disconnects the connection with the wired power line, or instructs to finish charging using the video/audio output unit 211 and the operation unit 212 of the charger (Step S1095). The communication unit 214 of the charger transmits, to the corresponding cloud, charge information including a charging time, a charge amount, a charger ID (information for identifying the charger), the vehicle ID, and the company electronic key 81 (electronic key ID), and payment information including a charge fee and payment method information (Step S1096).

The computing unit 503 of the corresponding cloud that has received the pieces of information makes a payment using a payment method correlated with the company electronic key 81 (Step S1097). Further, the communication unit 501 of the cloud transmits the charge information and the payment information to the information terminal 61 in order to present the charge information and the payment information to the user C (Step S1131).

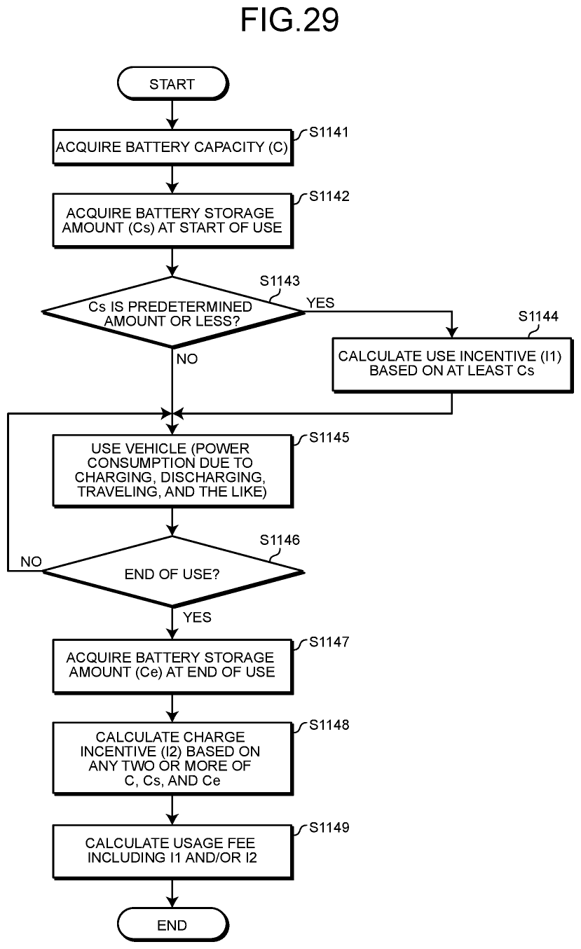

FIG. 29 is a flowchart for explaining a method for calculating a usage fee to a shared car operating company in FIGS. 21, 22, and 23.

The computing unit 106 of the vehicle 111 (the key management cloud 10 or the information terminal 61 may perform the processing) acquires a battery capacity (C) of the vehicle 111 (Step S1141). In addition, the battery management unit 121 of the vehicle 111 acquires a battery storage amount (Cs) at a moment when the user C starts using the vehicle 111 (Step S1142). Here, if a value of Cs (or a value of Cs/C) is equal to or less than a predetermined amount, then the processing proceeds to Yes (Step S1143: Yes), and a use incentive (I1) is calculated based on at least the value of Cs (Step S1144). Then, the user C uses the vehicle 111 (Step S1145).

Thereafter, the vehicle 111 continues to be used until the end of use of the vehicle 111 is Yes (Step S1146: Yes). Here, the battery of the vehicle 111 has power consumption due to charging, discharging, traveling, and the like, and the battery storage amount changes while the vehicle 111 is used.

When the use of the vehicle 111 is finished, the processing proceeds to Yes (Step S1146: Yes), and the battery management unit 121 acquires the battery storage amount (Ce) at the end of use (Step S1147). The computing unit 503 of the key management cloud 10 calculates a charge incentive (I2) based on any two or more of the battery capacity (C), the battery storage amount (Cs) at the start of use, and the battery storage amount (Ce) at the end of use (Step S1148).

The computing unit 503 of the key management cloud 10 calculates the usage fee including the use incentive (I1) and/or a use incentive (I2), and finishes the usage fee calculation processing (Step S1149). The use incentive (I1) may be designed such that the user merit (discount amount or discount rate) decreases in stages as the value of Cs or Cs/C increases. Conversely, the use incentive (I1) may be designed such that the user merit (discount amount or discount rate) increases as the value of Cs or Cs/C decreases.

The use incentive (I2) may be designed such that the user merit increases in stages as the value of Ce, Ce/C, (Ce-Cs), or (Ce-Cs)/C increases. Conversely, the use incentive (I2) may be designed such that the user merit decreases or the demerit such as a surcharge increases as the value of Ce, Ce/C, (Ce-Cs), or (Ce-Cs)/C decreases.

In this way, in a case where the battery storage amount at the start of use is lower than the predetermined amount, in a case where the battery storage amount at the end of use is higher than the predetermined amount, or the like, the usage fee can be discounted. In addition, in a case where the amount of change in the battery storage amount between the end of use and the start of use (amount of change before and after use) is a positive value, a discount according to the value can be given, and in a case where the amount of change in the battery storage amount between the end of use and the start of use is a negative value, a surcharge according to the value can be given.

A certain amount or more of the battery storage amount at the start of use is very useful for the next user's experience. Accordingly, such a use incentive is set based on the value of the battery storage amount of the vehicle 111 or the amount of change therein and the shared car operating company incorporates the use incentive into the usage fee, which makes it possible to motivate all users to increase the battery storage amount at the time of return. This is also useful for reducing the maintenance cost for managing the charge amount of each vehicle 111 to a certain amount or more by the shared car operating company.

Note that, here, the value per 1 Wh (for example, JPY/Wh), which is a rate of the use incentive, may be set at an individual rate by the shared car operating company. Surplus power obtained by solar power generation at home can be sold by charging the surplus power to the shared car and returning the vehicle 111, or, a shared car is rented at the time of power failure and power is supplied from the shared car to home to operate home facilities and home electric appliances at home, and the usage fee of the shared car according to the amount of power used can be paid.

Note that the incentive for the usage fee may be calculated not only depending on the battery storage amount but also including the fact that there is a charging facility in a parking lot where the shared car is returned and the shared car is connected to a charging plug at the time of return, or the shared car is returned at a parking lot near a charging station.

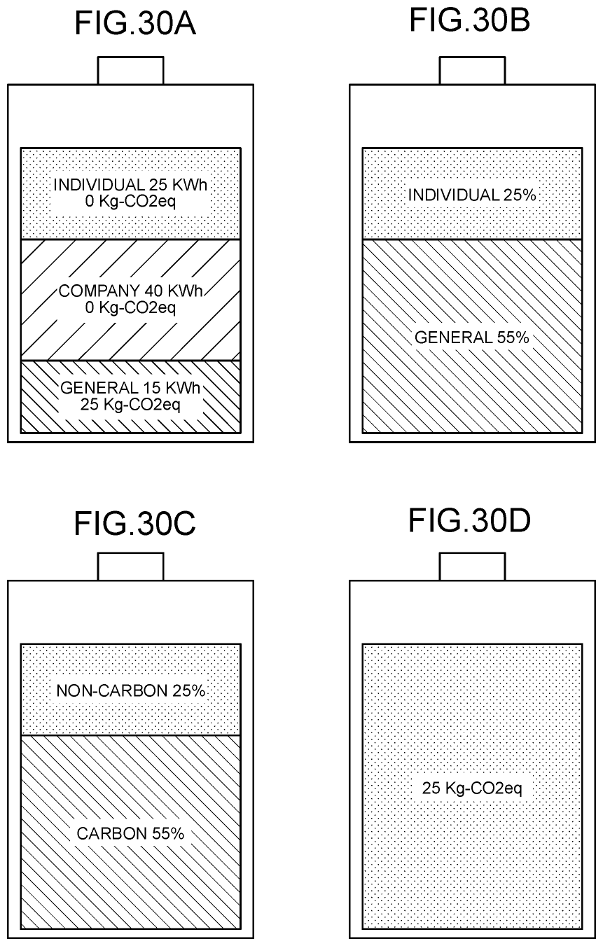

FIGS. 30A to 30D are diagrams illustrating examples in which the battery storage amount of the vehicle 111 is displayed in the information input/output unit 104 of the vehicle 111. In FIG. 26, the classification of the battery storage amount is represented as “general”, “company”, and “individual” according to the owner of electricity, but this may be presented to the user C in the indicator indicating the battery storage amount.

In FIG. 30A, the battery storage amount is displayed based on the classification according to the owner of electricity. The ownership of the shared car operating company indicated as “general” is 15 KWh, and the CO2 equivalent of carbon emissions in the case of using this electricity is 25 Kg-CO2 eq. This indicates how much carbon emissions are achieved by using “general” electricity. As for “company”, the ownership of a corporation/organization indicated by the company electronic key 81 and the carbon emissions thereof are indicated, and, as for “individual”, the ownership of an individual user and the carbon emissions thereof are indicated. Here, as for “company” and “individual”, electric power using 100% of renewable energy such as solar power generation is used, and thus the carbon emissions are displayed as 0 Kg-CO2 eq.

In a case where the first electronic key is the first company key, the indicator displayed in the display includes a first object (the battery storage amount of the company illustrated in FIG. 30A, for example) indicating a first storage amount owned by the first business entity and a second object (the individual and general battery storage amounts illustrated in FIG. 30A, for example) indicating another storage amount not owned by the first business entity.

Such display enables recognizing a difference in carbon emissions and global environmental load at the time of power generation even for the same electricity. FIGS. 30C and 30D illustrate another display mode of the battery storage amount and the user C can switch the display mode. FIG. 30C illustrates a storage amount of power derived from non-carbon and carbon. FIG. 30D illustrates carbon emissions at the time of power generation of the entire electricity stored in the battery.

In FIG. 30B, the storage amount classified as “general” which is owned by the shared car operating company and the storage amount classified as “individual” which is owned by the individual user are displayed separately at the start of use in FIG. 26. Ina case where the first electronic key is the first personal key, the indicator displayed in the display includes a third object (the battery storage amount of the individual illustrated in FIG. 30B, for example) indicating a second storage amount owned personally by the first user and a fourth object (the general battery storage amount illustrated in FIG. 30B, for example) indicating another storage amount not owned by the first user.

As a result, in a case where the use incentive as illustrated in FIG. 29 is applied, the user C who uses the shared car can easily estimate the use incentive incorporated in the usage fee. In the above description, the battery storage amount is indicated in units of KWh, but the present disclosure is not limited thereto, and may be expressed in units of % where the storage amount of the entire battery is 100%, or may be expressed in units of Km or miles indicating an estimated travel distance.

Similarly, in the above description, Kg-CO2 eq is used as a unit of the CO2 equivalent of carbon emissions, but the present disclosure is not limited thereto, and Kg-CO2 eq/Wh indicating a carbon emissions equivalent per 1 Wh, Kg-CO2 eq/Km indicating a carbon emissions equivalent per 1 Km, or Kg-CO2 eq/% indicating a carbon emissions equivalent per 1% battery consumption may be used.

In the above description, expression is made according to the classification of the owner (or purchaser) of electricity, but the present disclosure is not limited thereto, and expression may be made according to the classification of the owner of the charger that has charged the electricity. It is possible to identify the charged electricity and the owner of the charger used for charging based on charger ID information exchanged at the time of charging and discharging.

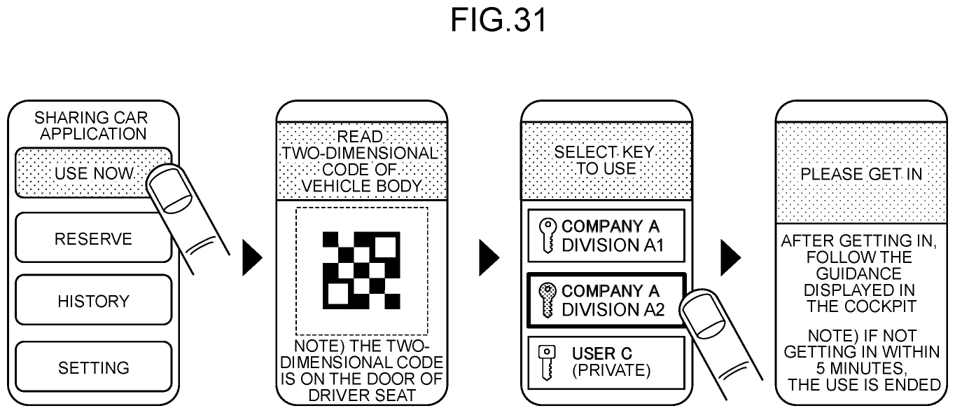

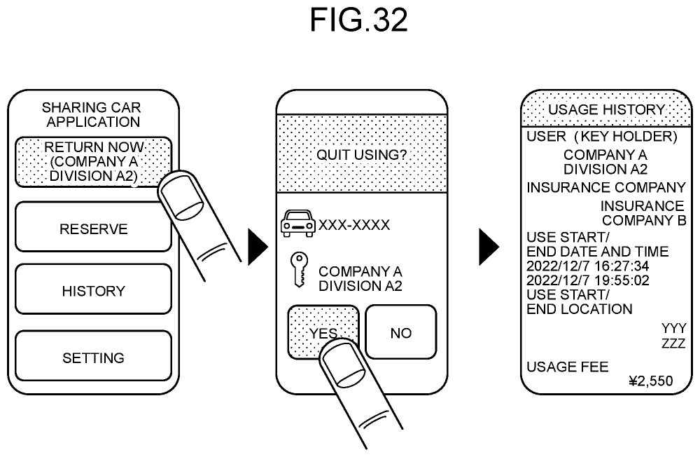

FIGS. 31 and 32 are diagrams illustrating screen transitions of the information terminal 61 at the start of use and at the end of use, respectively. FIG. 31 illustrates screen transitions at the start of use. First, the user C launches an application “sharing car application” for using a shared car installed on the information terminal 61. The launched screen is the first screen, and the screen displays a “use now” button for starting using immediately, a “reserve” button for booking a shared car, a “history” button for confirming the past usage history, and a “settings” button for confirming and setting personal information of the user C and setting information of an electronic key.

In a case where the user C selects the “use now” button by a touch operation or the like via the operation unit 603, the screen transitions to a screen for reading a two-dimensional code attached to the vehicle 111 in order to identify a vehicle 111 to be used. The user C positions the two-dimensional code of the vehicle 111 within the dashed square of the screen, so that the sharing car application can identify the vehicle 111 (vehicle ID).

In a case where the vehicle 111 is identified, the screen transitions to a screen for selecting a key to use the vehicle 111. Here, three keys are illustrated. The three keys displayed are a first key selected in a case where the vehicle 111 is used for the purpose of business of the division A1 of the company A, a second key selected in a case where the vehicle 111 is used for the purpose of business of the division A2 of the same company A that the user C concurrently serves, and a third key selected in a case where the user C uses the vehicle 111 for private purpose. In FIG. 31, the user C selects the second key according to the purpose of vehicle use. Specifically, the user C intends to use the vehicle 111 for the purpose of business of the division A2 where the user C concurrently serves.

In response to the key selected, the computing unit 503 of the key management cloud 10 determines whether the vehicle 111 is available, and in a case where the use is permitted, a message indicating that the vehicle 111 can be used is displayed. In this example, the user C is notified that, after getting in the vehicle 111, the information input/output unit 104 (a monitor located in the cockpit, for example) provided in the vehicle 111 presents guidance on a method of starting the vehicle 111, an operation method for the end of use, and the like.

Further, in a case where the act of getting in the vehicle 111 is not detected within a predetermined time (for example, when none of the doors and the trunk of the vehicle 111 are unlocked), the use may be automatically terminated. The function of the automatic cancellation and the presentation thereof are used to prevent an increase in the usage fee for the person who made the reservation to a predetermined amount or more and also to accommodate the vehicle 111 to another potential user in a case where the start of use is not detected even after a predetermined time elapses from the use start time of the reserved vehicle 111.

FIG. 32 illustrates screen transitions at the end of use. In a case where the user C operates the end of use with the information terminal 61, the user C can terminate the use by launching the sharing car application and selecting a “return now” button. For easy understanding, information indicating a key corresponding to the end of use may be displayed on the screen. In response to the “return now” button selected, the screen transitions to a confirmation screen for the end of use. On the confirmation screen, information on vehicle (exterior video of the vehicle 111, license plate of the vehicle 111, and the like) for which the use is finished and key information (information about the key owner and the like) are displayed on the information terminal 61.

In a case where the intention to terminate the use is confirmed on the confirmation screen, the usage history information (usage summary information in FIGS. 21, 22, and 23) including the used user, the used key, the used vehicle, the use start/end date and time, the use start/end place, and the usage fee is displayed.

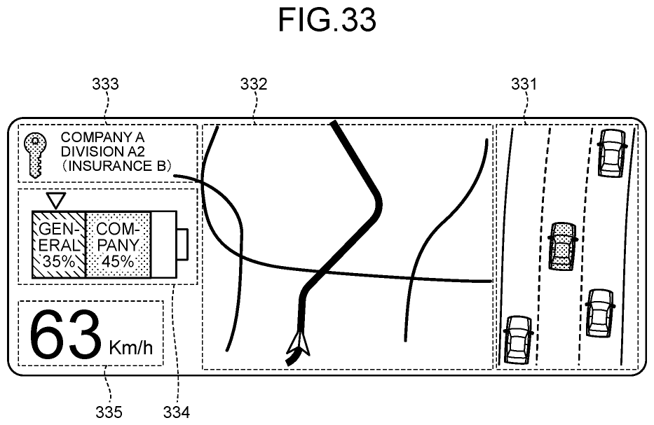

FIG. 33 is a diagram illustrating an example of a cockpit during use of a vehicle. As illustrated in FIG. 33, bird's-eye view information 331 indicating a relative positional relationship with another vehicle, a passerby, and the like with respect to the subject vehicle, navigation information 332 indicating a route to a destination and a map of the area around the subject vehicle, key information 333 indicating a key and an insurance that are currently used, battery information 334 indicating a current battery storage amount, and current traveling speed information 335 are displayed.

The key information is displayed in the cockpit (inside the vehicle), the user C who uses the vehicle 111 can easily recognize the key being used. In other words, it is possible to easily recall the purpose of use of the vehicle 111 correlated with the key (in the diagram, since the company electronic key 81 is used, the user is on duty of the division A2 where the user C concurrently serves), to prevent the use for purposes other than business purposes, and expect a psychological effect of concentrating on business.

In the battery information, a triangular mark indicates an estimated remaining battery level when the vehicle arrives at the destination. The user C can check the information to find out whether or not it is possible to reach the destination without charging. Such display can prompt the user to charge at an appropriate timing, and reduce the anxiety that the charge is depleted and the user cannot move on the way.

### Other Embodiments

The programs executed by the key management system 100 and the key management system 200 may be incorporated in advance in a ROM or the like and provided.

The programs executed by the key management system 100 and the key management system 200 may be recorded in a non-transitory computer-readable recording medium such as a CD-ROM, a flexible disk (FD), a CD-R, or a digital versatile disk (DVD) as a file in an installable format or an executable format and provided.

Further, the programs executed by the key management system 100 and the key management system 200 may be stored on a computer connected to a network such as the Internet and downloaded via the network and provided. Further, the programs executed by the key management system 100 and the key management system 200 may be provided or distributed via a network such as the Internet.

According to the present disclosure, further improvement can be made.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A control method
in a first computer configured to access at least one database managing vehicle information on a plurality of vehicles and a plurality of electronic keys corresponding to the plurality of vehicles, the control method comprising:
receiving, from a first terminal of a first user via a network, first authentication information including a first electronic key available to the first user and a first vehicle identification (ID) for identifying a first vehicle that the first user requests to use;
determining that the first authentication information is valid based on the first electronic key, the first vehicle ID, and the at least one database, and then transmitting, to the first vehicle via the network, a first permission signal indicating that the first user is permitted to use the first vehicle;
after the first user starts using the first vehicle, acquiring first use information indicating a status of use of the first vehicle from the first vehicle via the network;
transmitting, in a case where the first electronic key is a first company key correlated with a first business entity that the first user belongs to, at least a part of the first use information to a second computer related to the first business entity via the network; and
not transmitting, in a case where the first electronic key is a first personal key of the first user, the at least a part of the first use information to the second computer.

2. The control method according to claim 1, wherein
in the first terminal, a plurality of first electronic keys including the first company key and the first personal key is stored,
the first electronic key is one selected from among the plurality of first electronic keys in the first terminal, and
the first permission signal includes an unlock instruction for unlocking a door of the first vehicle.

3. The control method according to claim 1, wherein
the second computer is a computer used by a first insurance company with which the first business entity has a contract of a first automobile insurance.

4. The control method according to claim 3, comprising
transmitting, in a case where the first electronic key is the first personal key, at least a part of the first use information to a third computer, wherein
the third computer is a computer used by a second insurance company with which the first user personally has a contract of a second automobile insurance.

5. The control method according to claim 4, further comprising
in a case where the first electronic key is the first company key,
after determining that the first authentication information is valid, transmitting a first check request for requesting confirmation of an insurance for which the first business entity has a contract with the first insurance company to the second computer via the network,
receiving, in the second computer, based on the first check request, a first check result indicating that a contract detail of the first automobile insurance has been confirmed from the second computer via the network, and
after receiving the first check result, transmitting the first permission signal to the first vehicle.

6. The control method according to claim 5, further comprising
in a case where the first electronic key is the first personal key,
after determining that the first authentication information is valid, transmitting a second check request for requesting confirmation of an insurance for which the first user has a contract with the second insurance company to the third computer via the network,
receiving, in the third computer, based on the second check request, a second check result indicating that a contract detail of the second automobile insurance has been confirmed from the third computer via the network, and
after receiving the second check result, transmitting the first permission signal to the first vehicle.

7. The control method according to claim 6, wherein
in a case where the first electronic key is the first company key, the first permission signal includes a first display instruction for causing first insurance information indicating at least a part of the contract detail of the first automobile insurance to be displayed in a display provided in a vehicle interior of the first vehicle, and
in a case where the first electronic key is the first personal key, the first permission signal includes a second display instruction for causing second insurance information indicating at least a part of the contract detail of the second automobile insurance to be displayed in the display.

8. The control method according to claim 6, further comprising
in a case where the first electronic key is the first personal key, and further in a case where an automobile insurance contracted personally by the first user is not identified, transmitting, to the first vehicle via the network, a display instruction signal for displaying recommended insurance information indicating an automobile insurance to be recommended to the first user in a display provided in a vehicle interior of the first vehicle,
receiving a third check result indicating that the first user has taken the recommended automobile insurance from the first vehicle via the network, and
after receiving the third check result, permitting the first user to use the first vehicle.

9. The control method according to claim 4, wherein
the at least one database further
manages insurance company information and address information, the insurance company information being related to a plurality of insurance companies with which a plurality of users or a plurality of business entities to which the plurality of users belongs has a contract, the address information indicating network addresses of a plurality of computers used by the plurality of insurance companies,
in a case where the first electronic key is the first company key, first address information indicating a network address of the second computer used by the first insurance company is identified by checking the first company key with the at least one database, and
in a case where the first electronic key is the first personal key, second address information indicating a network address of the third computer used by the second insurance company is identified by checking the first personal key with the at least one database.

10. The control method according to claim 4, wherein
in a case where the first electronic key is the first company key, the first authentication information further includes first address information indicating a network address of the second computer used by the first insurance company, and
in a case where the first electronic key is the first personal key, the first authentication information further includes second address information indicating a network address of the third computer used by the second insurance company.

11. The control method according to claim 1, wherein
the second computer is a business computer used by the first business entity, and
in a case where the first electronic key is the first company key, the at least a part of the first use information transmitted to the second computer includes the first vehicle ID and a first travel history in which location information of the first vehicle is correlated with time information.

12. The control method according to claim 11, further comprising
in a case where the first electronic key is the first company key, transmitting a first setting instruction for setting a control mode of the first vehicle to a company vehicle mode to the first vehicle via the network, and
in a case where the first electronic key is the first personal key, transmitting a second setting instruction for setting the control mode of the first vehicle to a private vehicle mode to the first vehicle via the network.

13. The control method according to claim 12, wherein
a first travel distance of a first route from a first departure place to a first destination in the company vehicle mode is longer than a second travel distance of a second route from the first departure place to the first destination in the private vehicle mode, or, alternatively,
a first travel time taken in a case of traveling from the first departure place to the first destination in the company vehicle mode is longer than a second travel time taken in a case of traveling from the first departure place to the first destination in the private vehicle mode.

14. The control method according to claim 12, wherein
in the company vehicle mode, first advertisement information for the first user is displayed in a display provided in a vehicle interior of the first vehicle,
in the private vehicle mode, second advertisement information for the first user is displayed in the display, and
at least one of a display frequency, a display position, or a display content of the first advertisement information is different from that of the second advertisement information.

15. The control method according to claim 11, further comprising
at a start of using the first vehicle with the first company key, acquiring first battery information indicating a first storage amount stored in a battery mounted on the first vehicle from the first vehicle via the network,
at an end of using the first vehicle with the first company key, acquiring second battery information indicating a second storage amount stored in the battery from the first vehicle via the network, and
executing payment processing with an amount of money reflecting an amount of change from the first storage amount to the second storage amount for the business computer used by the first business entity, or, for a financial computer used by a financial institution managing a payment method of the first business entity.

16. The control method according to claim 11, further comprising
at a start of using the first vehicle with the first company key, acquiring first battery information indicating a first storage amount stored in a battery mounted on the first vehicle from the first vehicle via the network,
at an end of using the first vehicle with the first company key, acquiring second battery information indicating a second storage amount stored in the battery from the first vehicle via the network,
executing payment processing with an amount of money reflected in at least one of the first storage amount and the second storage amount for the business computer used by the first business entity, or, for a financial computer used by a financial institution managing a payment method of the first business entity, and
in the payment processing, in a case where the first storage amount is equal to or less than a first reference amount, or, in a case where the second storage amount is equal to or more than a second reference amount, the amount of money is subtracted from a predetermined amount of money.

17. The control method according to claim 11, further comprising
after a charging operation by a first charger is performed on a battery mounted on the first vehicle in a use period of the first vehicle with the first company key, receiving a first payment report indicating that payment processing has been performed between the first charger and the business computer used by the first business entity or a financial computer used by a financial institution managing a payment method of the first business entity from the first charger, the business computer, or the financial computer via the network, and
correlating the first payment report with the first company key to record a resultant in a memory of the first computer.

18. The control method according to claim 1, further comprising
after determining that the first authentication information is valid, transmitting, to the first vehicle via the network, display setting information for displaying an indicator indicating a storage amount of the battery in a display in a vehicle interior of the first vehicle based on information on a charging history of a battery mounted on the first vehicle, wherein
the charging history is stored in a memory of the first computer,
in a case where the first electronic key is the first company key, the indicator displayed in the display includes a first object indicating a first storage amount owned by the first business entity and a second object indicating another storage amount not owned by the first business entity, and
in a case where the first electronic key is the first personal key, the indicator displayed in the display includes a third object indicating a second storage amount owned personally by the first user and a fourth object indicating another storage amount not owned by the first user.

19. A computer program product including programmed instructions embodied in and stored on a non-transitory computer readable medium, wherein the instructions, when executed by a computer, the computer program product causing the first computer to perform the control method according to claim 1.

20. A non-transitory computer readable storage medium having stored thereon a computer program product including programmed instructions embodied in and stored on a non-transitory computer readable medium, wherein the instructions, when executed by a computer, the computer program product causing the first computer to perform the control method according to claim 1.
